(19) United States
(12) Patent Application Publication
(10) Pub. No.: US 2022/0057546 A1
(43) Pub. Date: Feb. 24, 2022

(54) LIQUID LENSES

(71) Applicant: CORNING INCORPORATED, Corning, NY (US)

(72) Inventors: James Lewis Dale, Rio Rancho, NM (US); Raymond Miller Karam, Santa Barbara, CA (US); Paul Ewing Langenbacher, Ithaca, NY (US); Dragan Pikula, Horseheads, NY (US); Daniel Ohen Ricketts, Corning, NY (US); Ernesto Sanchez, JR., Ventura, CA (US); ChuanChe Wang, Horseheads, NY (US); Jia Zhang, Painted Post, NY (US)

(21) Appl. No.: 17/521,321

(22) Filed: Nov. 8, 2021

Related U.S. Application Data
(63) Continuation of application No. PCT/US2020/031812, filed on May 7, 2020.
(60) Provisional application No. 62/845,958, filed on May 10, 2019.
(60) Provisional application No. 62/988,505, filed on Mar. 12, 2020.

(51) Int. Cl. G02B 3/14; G02B 26/00

(52) U.S. Cl. CPC G02B 3/14; G02B 26/005

(57) ABSTRACT

A liquid lens can include a first substrate with an interior recess. A second substrate with a bore can be bonded to the first substrate, whereby the interior recess of the first substrate and the bore of the second substrate cooperatively define at least a portion of a cavity of the liquid lens. A first liquid and a second liquid can be disposed in the cavity. A variable interface can be disposed between the first liquid and the second liquid, thereby forming a variable lens. The interior recess of the first substrate can be positioned outside of a sidewall projection of a sidewall surface of the cavity through the first substrate.

### CROSS-REFERENCE TO RELATED APPLICATIONS

This application is a continuation of International Application No. PCT/US2020/031812, filed May 7, 2020, which claims the benefit of priority under 35 U.S.C. § 119 of U.S. Provisional Application Nos. 62/845,958, filed May 10, 2019, and 62/988,505, filed Mar. 12, 2020, the content of each of which is incorporated herein by reference in its entirety.

### BACKGROUND

### 1. Field

This disclosure relates to liquid lenses, and more particularly, liquid lenses with improved speed, image quality, and/or manufacturability and liquid lenses with improved cavity and/or flexure designs.

### 2. Technical Background

Liquid lenses generally include two immiscible liquids disposed within a chamber. Varying the electric field to which the liquids are subjected can vary the wettability of one of the liquids with respect to the chamber wall, thereby varying the shape of the meniscus formed between the two liquids.

### SUMMARY

Disclosed herein are liquid lenses.

Disclosed herein is a liquid lens comprising a first substrate comprising a peripheral portion, a first window, and a recess disposed between the peripheral portion and the first window. A cavity is disposed between the first substrate and a second window. A first liquid and a second liquid are disposed within the cavity. The liquid lens comprises a common electrode, a driving electrode, and an insulating layer disposed within the cavity to insulate the driving electrode from each of the first liquid and the second liquid. An exposed portion of the common electrode disposed laterally between an edge of the insulating layer and the peripheral portion of the first substrate is in electrical communication with the first liquid via a portion of the first liquid disposed within the recess of the first substrate.

Disclosed herein is a liquid lens comprising a first substrate comprising a first window and a peripheral portion disposed laterally outboard of the first window. The liquid lens comprises a second substrate and a cavity disposed at least partially within a bore of the second substrate and between the first substrate and a second window. A sidewall of the cavity comprises a first portion extending at an angle α to a structural axis of the liquid lens, a second portion disposed between the first portion of the sidewall and the first substrate and extending at an angle β to the structural axis, and a transition disposed between the first portion of the sidewall and the second portion of the sidewall. A first liquid and a second liquid are disposed within the cavity. The liquid lens comprises a common electrode, a driving electrode, and an insulating layer disposed on the sidewall of the cavity to insulate the driving electrode from each of the first liquid and the second liquid. The peripheral portion of the first substrate is bonded to the second substrate to seal the first liquid and the second liquid within the cavity. An edge of the insulating layer can be at least partially disposed within the cavity, and an exposed portion of the common electrode disposed within the cavity and laterally outboard of the edge of the insulating layer can be in electrical communication with the first liquid. Additionally, or alternatively, the angle α is smaller than the angle β. Additionally, or alternatively, the transition of the sidewall serves as an aperture stop of the liquid lens. Additionally, or alternatively, a ratio of a volume of an upper portion of the cavity defined by the second portion of the sidewall to a total volume of the cavity is about 0.4 to about 0.6.

Disclosed herein is a liquid lens comprising a first substrate comprising a first window and a peripheral portion disposed laterally outboard of the first window. The liquid lens comprises a second substrate and a cavity disposed at least partially within a bore of the second substrate and between the first substrate and a second window. The cavity comprises a sidewall extending between the first substrate and the second window and a step disposed between the sidewall and the first substrate. A first liquid and a second liquid are disposed within the cavity. The liquid lens comprises a common electrode, a driving electrode, and an insulating layer disposed within the cavity to insulate the driving electrode from each of the first liquid and the second liquid. The step comprises a first tread portion proximate the first substrate, a second tread portion axially offset from the first tread portion, and a riser portion disposed between the first tread portion and the second tread portion. At least a portion of an edge of the insulating layer can be disposed on the step between the first substrate and the second substrate. An exposed portion of the common electrode disposed within the cavity and laterally outboard of the edge of the insulating layer can be in electrical communication with the first liquid.

Disclosed herein is a liquid lens comprising a first substrate comprising an interior recess, a second substrate comprising a bore and bonded to the first substrate, whereby the interior recess of the first substrate and the bore of the second substrate cooperatively define at least a portion of a cavity of the liquid lens, a first liquid disposed in the cavity, a second liquid disposed in the cavity, and a variable interface disposed between the first liquid and the second liquid, thereby forming a variable lens. The interior recess of the first substrate can be positioned outside of a sidewall projection of a sidewall surface of the cavity through the first substrate.

Disclosed herein is a liquid lens comprising a first substrate comprising an interior recess and a substantially planar exterior surface, the interior recess comprising an annular shape, a second substrate comprising a bore and bonded to the first substrate, whereby the interior recess of the first substrate and the bore of the second substrate cooperatively define at least a portion of a cavity of the liquid lens, a first liquid disposed in the cavity, a second liquid disposed in the cavity, and a variable interface disposed between the first liquid and the second liquid, thereby forming a variable lens. The cavity can comprise a sidewall surface and a chamfer surface disposed between the sidewall surface and the first substrate, wherein a sidewall angle between the sidewall surface and a structural axis of the liquid lens is less than a chamfer angle between the chamfer surface and the structural axis of the liquid lens. The interior recess of the first substrate can be positioned outside of a sidewall projection of the sidewall surface through the first substrate.

Disclosed herein is a liquid lens comprising a first substrate comprising an interior recess and an exterior recess, the interior recess extending across a window of the first substrate, the exterior recess comprising an annular recess, a second substrate comprising a bore and bonded to the first substrate, whereby the interior recess of the first substrate and the bore of the second substrate cooperatively define at least a portion of a cavity of the liquid lens, the cavity comprising a sidewall surface disposed at a sidewall angle between the sidewall surface and a structural axis of the liquid lens, a first liquid disposed in the cavity, a second liquid disposed in the cavity, and a variable interface disposed between the first liquid and the second liquid, thereby forming a variable lens. Light passing directly through the liquid lens at any angle within a sidewall projection of the sidewall surface can pass through the first substrate without passing through an edge of the interior recess. The exterior recess can be positioned outside of the sidewall projection of the sidewall surface of the cavity through the first substrate.

It is to be understood that both the foregoing general description and the following detailed description are merely exemplary and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic cross-sectional view of some embodiments of a liquid lens.

FIG. 2 is a schematic cross-sectional view of some embodiments of the liquid lens shown in FIG. 1 with a varied focal length compared to FIG. 1.

FIG. 3 is a schematic cross-sectional view of some embodiments of the liquid lens shown in FIG. 1 with a varied tilt compared to FIG. 1.

FIG. 4 is a schematic front view of the liquid lens shown in FIG. 1 looking through a first outer layer of the liquid lens.

FIG. 5 is a schematic rear view of the liquid lens shown in FIG. 1 looking through a second outer layer of the liquid lens.

FIG. 6 is a close-up view of a portion of the liquid lens shown in FIG. 1.

FIG. 7 is a schematic cross-sectional view of some embodiments of a liquid lens.

FIG. 8 is a schematic cross-sectional view of some embodiments of a liquid lens without a multi-angle sidewall.

FIG. 9 is a schematic cross-sectional view of some embodiments of a liquid lens with a multi-angle sidewall.

FIG. 10 is a schematic cross-sectional view of some embodiments of a liquid lens.

FIG. 11 is a schematic cross-sectional view of some embodiments of a liquid lens.

FIG. 12 is a schematic cross-sectional view of some embodiments of a liquid lens.

FIG. 13 is a schematic cross-sectional view of some embodiments of a liquid lens.

FIG. 14 is a schematic cross-sectional view of some embodiments of an imaging device.

FIG. 15 is a block diagram illustrating some embodiments of an imaging system.

FIG. 16 is a schematic ray diagram of some embodiments of the imaging device shown in FIG. 14.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, unless otherwise indicated, the term “formed from” can refer to any of comprising, consisting of, or consisting essentially of. Thus, disclosure of a component formed from a particular material includes disclosures of embodiments of each of the component comprising the particular material, the component consisting essentially of the particular material, and the component consisting of the particular material.

As used herein, unless otherwise indicated, the term “optical density” refers to a measure of the transmittance through an optical medium, and can be calculated according to the following equation:

D_{λ}=−log₁₀ τ_{λ}

where D_{λ} is the optical density at a wavelength λ, and τ_{λ} is the transmittance at the wavelength λ. The optical density can be presented at a single wavelength or as the average over a wavelength range. For example, the optical density can be presented as the average (e.g., mean) optical density over the visible spectrum (e.g., a wavelength range of 400 nm to 700 nm).

In various embodiments, a liquid lens comprises a first substrate comprising a peripheral portion, a first window, and a recess disposed between the peripheral portion and the first window. In some embodiments, a cavity is disposed between the first substrate and a second window, and a first liquid and a second liquid are disposed within the cavity. In some embodiments, the liquid lens comprises a common electrode, a driving electrode, and an insulating layer disposed within the cavity to insulate the driving electrode from each of the first liquid and the second liquid. In some embodiments, an exposed portion of the common electrode disposed laterally between an edge of the insulating layer and the peripheral portion of the first substrate is in electrical communication with the first liquid via a portion of the first liquid disposed within the recess of the first substrate.

The first substrate with the recess disposed between the peripheral portion and the first window can help to maintain a gap between a lip of the cavity (e.g., an upper edge of the cavity sidewall and/or an upper edge of the cavity step) and the first substrate. Such a gap can enable the insulating layer to wrap over the lip of the cavity without contacting the first substrate and/or enable the first liquid to occupy a portion of the recess and the gap to maintain electrical communication between the common electrode and the first liquid (e.g., to maintain electrical communication with a bulk of the first liquid disposed in the cavity via the recess and the gap). Additionally, or alternatively, the recess of the first substrate can enable the first window to move axially without contacting the lip of the cavity. For example, the lip of the cavity can be received within the recess as the first window translates in a downward or image side direction. Such lack of contact can enable a relatively thick first window (e.g., having substantially the same thickness as the peripheral portion of the first substrate). Such a relatively thick first window can enable improved manufacturability (e.g., by reducing or even eliminating an etching step to thin the first window relative to the peripheral portion of the first substrate) and/or improved image quality (e.g., reducing or eliminating etching of the first window, thereby maintaining a pristine window surface, and/or by increasing the stiffness of the first window, thereby reducing changes in curvature of the first window with changing temperature).

In various embodiments, a liquid lens comprises a first substrate comprising a first window and a peripheral portion disposed laterally outboard of the first window. In some embodiments, the liquid lens comprises a second substrate and a cavity disposed at least partially within a bore of the second substrate and between the first substrate and a second window. In some embodiments, a sidewall of the cavity comprises a first portion extending at an angle α to a structural axis of the liquid lens, a second portion disposed between the first portion of the sidewall and the first substrate and extending at an angle β to the structural axis, and a transition disposed between the first portion of the sidewall and the second portion of the sidewall. In some embodiments, the liquid lens comprises a first liquid disposed within the cavity, a second liquid disposed within the cavity, a common electrode, a driving electrode, and an insulating layer disposed on the sidewall of the cavity to insulate the driving electrode from each of the first liquid and the second liquid. In some embodiments, the peripheral portion of the first substrate is bonded to the second substrate to seal the first liquid and the second liquid within the cavity. Additionally, or alternatively, an edge of the insulating layer is at least partially disposed within the cavity, and an exposed portion of the common electrode disposed within the cavity and laterally outboard of the edge of the insulating layer is in electrical communication with the first liquid. Additionally, or alternatively, the angle α is smaller than the angle β. Additionally, or alternatively, the transition of the sidewall serves as an aperture stop of the liquid lens. Additionally, or alternatively, a ratio of a volume of an upper portion of the cavity (e.g., corresponding to the second portion of the sidewall) to a total volume of the cavity is about 0.4 to about 0.6.

The multi-angle cavity sidewall (e.g., the cavity sidewall with the first portion extending at the angle α, the second portion extending at the angle β, and the transition therebetween) can enable the liquid lens to have a relatively large clear aperture, a relatively fast response time, relatively good image quality, a relatively large field of view (FOV) and/or chief ray angle, and/or a relatively small thickness (e.g., short cavity height). For example, increasing the clear aperture of a liquid lens can lead to increasing the cavity height to maintain response time. However, increasing the ratio of the volume of the first liquid to the volume of the second liquid can improve response time for a given cavity height. Thus, increasing the volume of the portion of the cavity filled predominantly by the first liquid (e.g., by increasing the angle β) by a greater amount than increasing the volume of the portion of the cavity filled predominantly by the second liquid (e.g., by holding the angle α constant or increasing the angle α by less than the angle β) can help to maintain response time while increasing the clear aperture without increasing the cavity height. Additionally, or alternatively, widening an upper portion of the cavity sidewall (e.g., by increasing the angle β) can move the aperture stop of the liquid lens from the lip of the cavity to the transition between the first portion and the second portion of the cavity sidewall, which can increase the FOV and/or chief ray angle of the liquid lens without increasing the clear aperture or the cavity height.

In various embodiments, a liquid lens comprises a first substrate comprising a first window and a peripheral portion disposed laterally outboard of the first window. In some embodiments, the liquid lens comprises a second substrate and a cavity disposed at least partially within a bore of the second substrate and between the first substrate and a second window. In some embodiments, the cavity comprises a sidewall extending between the first substrate and the second window and a step disposed between the sidewall and the first substrate. In some embodiments, the liquid lens comprises a first liquid disposed within the cavity, a second liquid disposed within the cavity, a common electrode, a driving electrode, and an insulating layer disposed within the cavity to insulate the driving electrode from each of the first liquid and the second liquid. In some embodiments, the step comprises a first tread portion proximate the first substrate, a second tread portion axially offset from the first tread portion, and a riser portion disposed between the first tread portion and the second tread portion. Additionally, or alternatively, at least a portion of an edge of the insulating layer is disposed on the first tread portion of the step between the first substrate and the second substrate. Additionally, or alternatively, an exposed portion of the common electrode disposed within the cavity and laterally outboard of the edge of the insulating layer is in electrical communication with the first liquid.

The step disposed between the cavity sidewall and the first substrate can help to maintain a gap between the lip of the cavity and the first substrate. Such a gap can enable the insulating layer to wrap over the lip of the cavity without contacting the first substrate and/or enable the first liquid to occupy a portion of the gap to maintain electrical communication between the common electrode and the first liquid (e.g., as described herein in reference to the recess in the first substrate). Additionally, or alternatively, the gap can enable the first window to move axially without contacting the lip of the cavity. For example, the first window can flex into the gap as the first window moves axially in a downward or image side direction. Such lack of contact can enable a relatively thick first window and/or improved manufacturability (e.g., as described herein in reference to the recess in the first substrate).

In various embodiments, a liquid lens comprises a first substrate comprising an interior recess and a flexure corresponding to the interior recess. For example, the flexure comprises a thinned region of the first substrate disposed axially adjacent the interior recess. In some embodiments, a second substrate comprises a bore. The first substrate can be bonded to the second substrate, whereby the interior recess of the first substrate and the bore of the second substrate cooperatively define at least a portion of a cavity of the liquid lens. A first liquid and a second liquid can be disposed in the cavity. A variable interface can be disposed between the first liquid and the second liquid, thereby forming a variable lens. In some embodiments, the interior recess of the first substrate is positioned outside of a sidewall projection of a sidewall surface of the cavity through the first substrate. For example, the sidewall projection is an imaginary extension of the sidewall surface through the first substrate, thereby defining a conical or pyramidal projection volume, and the interior recess of the first substrate can be positioned outside of the projection volume. In some embodiments, light passing directly through the liquid lens at any angle within the sidewall projection of the sidewall surface of the cavity passes through the first substrate without passing through an edge of the interior recess. For example, light passing directly through the liquid lens at any angle falling within the conical or pyramidal projection volume defined by the sidewall projection passes through the first substrate, and the interior recess of the first substrate can be positioned outside of the projection volume. In some embodiments, the liquid lens comprises an exterior recess, and the flexure is disposed between the interior recess and the exterior recess. The exterior recess can be positioned outside of the projection volume. In some embodiments, the first substrate comprises a substantially planar exterior surface. Additionally, or alternatively, the interior recess comprises an annular shape. Additionally, or alternatively, the cavity comprises a chamfer surface disposed between the sidewall surface and the first substrate, and a sidewall angle between the sidewall surface and a structural axis of the liquid lens is less than a chamfer angle between the chamfer surface and the structural axis of the liquid lens.

The cavity configurations and positioning of the interior and/or exterior recesses as described herein can enable rays of light propagating directly through the liquid lens at angles falling within the sidewall projection to pass through the first substrate without passing through the interior and/or exterior recesses (or edges thereof). Because light could be distorted (e.g., refracted and/or reflected at various undesirable angles) upon passing through rough, curved, and/or angled surfaces of the interior or exterior recesses, configuring the liquid lens such that light passing through one or both of the interior or exterior recesses and/or edges thereof does not pass directly through the liquid lens (e.g., because it is clipped by the second substrate rather than passing through the bore) can help to avoid distortion of an image generated using the liquid lens. For example, the liquid lens configurations described herein can reduce stray light within the liquid lens, which can help to reduce or even eliminate flare present in the resulting image.

The various features described throughout this disclosure can be used individually or in various combinations. For example, any combination of two or more of the first substrate with the recess (e.g., the interior and/or exterior recesses having any of the various configurations described herein), the cavity sidewall (e.g., the single-angle or multi-angle cavity sidewall), the cavity chamfer, the cavity step, or the cavity face can be used to enable a liquid lens with various potential benefits as descried herein.

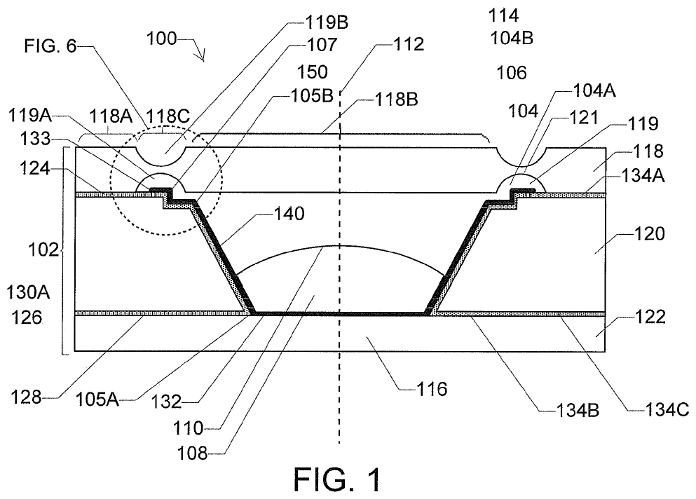

FIG. 1 is a schematic cross-sectional view of some embodiments of a liquid lens 100. In some embodiments, liquid lens 100 comprises a lens body 102 and a cavity 104 formed or disposed in the lens body. A first liquid 106 and a second liquid 108 can be disposed within cavity 104. In some embodiments, first liquid 106 is a polar liquid or a conducting liquid (e.g., an aqueous salt solution). Additionally, or alternatively, second liquid 108 is a non-polar liquid or an insulating liquid (e.g., an oil). In some embodiments, first liquid 106 and second liquid 108 have different refractive indices such that an interface 110 between the first liquid and the second liquid forms a lens. In some embodiments, first liquid 106 and second liquid 108 have substantially the same density, which can help to avoid changes in the shape of interface 110 as a result of changing the physical orientation of liquid lens 100 (e.g., as a result of gravitational forces).

In some embodiments, first liquid 106 and second liquid 108 are in direct contact with each other at interface 110. For example, first liquid 106 and second liquid 108 are substantially immiscible with each other such that the contact surface between the first liquid and the second liquid defines interface 110. In some embodiments, first liquid 106 and second liquid 108 are separated from each other at interface 110. For example, first liquid 106 and second liquid 108 are separated from each other by a membrane (e.g., a polymeric membrane) that defines interface 110.

In some embodiments, cavity 104 comprises a first portion, or headspace, 104A and a second portion, or base portion, 104B. For example, second portion 104B of cavity 104 is defined by a bore in an intermediate layer of liquid lens 100 as described herein. Additionally, or alternatively, first portion 104A of cavity 104 is defined by a recess in a first outer layer of liquid lens 100 and/or disposed outside of the bore in the intermediate layer as described herein. In some embodiments, at least a portion of first liquid 106 is disposed in first portion 104A of cavity 104. Additionally, or alternatively, second liquid 108 is disposed within second portion 104B of cavity 104. For example, substantially all or a portion of second liquid 108 is disposed within second portion 104B of cavity 104. In some embodiments, the perimeter of interface 110 (e.g., the edge of the interface in contact with the sidewall of the cavity) is disposed within second portion 104B of cavity 104.

Interface 110 can be adjusted via electrowetting. For example, a voltage can be applied between first liquid 106 (e.g., an electrode in electrical communication with the first liquid as described herein) and a surface of cavity 104 (e.g., an electrode positioned near the surface of the cavity and insulated from the first liquid as described herein) to increase or decrease the wettability of the surface of the cavity with respect to the first liquid and change the shape of interface 110 as described herein. In some embodiments, a refractive index of first liquid 106 is different than a refractive index of second liquid 108 such that light is refracted at interface 110 as described herein. For example, first liquid 106 has a lower refractive index or a higher refractive index than second liquid 108. Thus, interface 110 can function as a variable lens also as described herein.

In some embodiments, lens body 102 of liquid lens 100 comprises a first window 114 and a second window 116. In some of such embodiments, at least a portion of cavity 104 is disposed between first window 114 and second window 116. In some embodiments, lens body 102 comprises a plurality of layers that cooperatively form the lens body. For example, in the embodiments shown in FIG. 1, lens body 102 comprises a first outer layer 118 (e.g., a first substrate or a top plate), an intermediate layer 120 (e.g., a second substrate or a cone plate), and a second outer layer 122 (e.g., a third substrate or a bottom plate). In some of such embodiments, intermediate layer 120 comprises a bore formed therein (e.g., extending partially or entirely through the intermediate layer). First outer layer 118 can be bonded to one side (e.g., the object side or the top side) of intermediate layer 120. For example, first outer layer 118 is bonded to intermediate layer 120 at a bond 134A. Bond 134A can be an adhesive bond, a laser bond (e.g., a room temperature laser bond or a laser weld), or another suitable bond capable of maintaining first liquid 106 and second liquid 108 within cavity 104 (e.g., sealing the first liquid and the second liquid within the cavity, or hermetically sealing the cavity). Additionally, or alternatively, second outer layer 122 can be bonded to the other side (e.g., the image side or the bottom side) of intermediate layer 120 (e.g., opposite first outer layer 118). For example, second outer layer 122 is bonded to intermediate layer 120 at a bond 134B and/or a bond 134C, each of which can be configured as described herein with respect to bond 134A. In some embodiments, intermediate layer 120 is disposed between first outer layer 118 and second outer layer 122, the bore in the intermediate layer is covered on opposing sides by the first outer layer and the second outer layer, and at least a portion of cavity 104 is defined within the bore. Thus, a portion of first outer layer 118 covering cavity 104 serves as first window 114, and a portion of second outer layer 122 covering the cavity serves as second window 116.

In some embodiments, cavity 104 comprises first portion 104A and second portion 104B. For example, in the embodiments shown in FIG. 1, second portion 104B of cavity 104 is defined by the bore in intermediate layer 120, and first portion 104A of the cavity is disposed between the second portion of the cavity and first outer layer 118. In some embodiments, first outer layer 118 comprises a recess 119 as shown in FIG. 1, and first portion 104A of cavity 104 is disposed within the recess in the first outer layer. In some embodiments, first portion 104A of cavity 104 is disposed outside of the bore in intermediate layer 120. In some embodiments, a lip 107 of cavity 104 is disposed between first portion 104A and second portion 104B of the cavity. For example, lip 107 is defined by an upper edge of the bore in intermediate layer 120. In other embodiments, the lip is disposed between a sidewall and a step of the cavity or between a sidewall surface and a chamfer surface of the cavity. For example, the lip is defined by an upper edge of the sidewall surface (e.g., within the second portion of the cavity and/or the bore in the intermediate layer).

In some embodiments, cavity 104 or a portion thereof (e.g., second portion 104B of the cavity and/or an operating portion of the cavity as described herein) is tapered as shown in FIG. 1 such that a cross-sectional area of at least a portion of the cavity decreases along a structural axis 112 of liquid lens 100 in a direction from first window 114 toward second window 116 (e.g., from the object side toward the image side). For example, second portion 104B of cavity 104 comprises a conical or pyramidal shape (e.g., a truncated conical or pyramidal shape) with a narrow end 105A and a wide end 105B. The terms “narrow” and “wide” are relative terms, meaning the narrow end is narrower, or has a smaller width or diameter, than the wide end. Such a tapered cavity can help to maintain alignment of interface 110 between first liquid 106 and second liquid 108 along structural axis 112 and/or enable tilting of the interface relative to the structural axis as described herein. In other embodiments, the cavity is tapered such that the cross-sectional area of the cavity increases along the structural axis in the direction from first window 114 toward second window 116or non-tapered such that the cross-sectional area of the cavity remains substantially constant along the structural axis. In some embodiments, cavity 104 is rotationally symmetrical (e.g., about structural axis 112).

In some embodiments, image light enters liquid lens 100 through first window 114, is refracted at interface 110 between first liquid 106 and second liquid 108, and exits the liquid lens through second window 116. In some embodiments, first outer layer 118 and/or second outer layer 122 comprise a sufficient transparency to enable passage of the image light. For example, first outer layer 118 and/or second outer layer 122 comprise a polymeric, glass, ceramic, glass-ceramic material, or combination thereof. In some embodiments, outer surfaces of first outer layer 118 and/or second outer layer 122 (or portions thereof, such as first window 114 and/or second window 116) are substantially planar. Thus, even though liquid lens 100 can function as a lens (e.g., by refracting image light passing through interface 110), one or more outer surfaces of the liquid lens can be flat as opposed to being curved like the outer surfaces of a fixed lens. Such planar outer surfaces can make integrating liquid lens 100 into an optical assembly (e.g., a lens stack comprising one or more fixed lenses disposed in a housing or lens barrel) less difficult. In other embodiments, outer surfaces of the first outer layer and/or the second outer layer are curved (e.g., concave or convex). Thus, the liquid lens can comprise an integrated fixed lens. In some embodiments, intermediate layer 120 comprises a metallic, polymeric, glass, ceramic, glass-ceramic material, or combination thereof. Because image light can pass through the bore in intermediate layer 120, the intermediate layer may or may not be transparent.

Although lens body 102 of liquid lens 100 is described as comprising first outer layer 118, intermediate layer 120, and second outer layer 122, other embodiments are included in this disclosure. For example, in some other embodiments, one or more of the layers is omitted. For example, the bore in the intermediate layer can be configured as a blind hole that does not extend entirely through the intermediate layer, and the second outer layer can be omitted. Although first portion 104A of cavity 104 is described herein as being disposed within recess 119 in first outer layer 118, other embodiments are included in this disclosure. For example, in some other embodiments, the recess is omitted, and the first portion of the cavity is disposed within the bore in the intermediate layer. Thus, the first portion of the cavity is an upper portion of the bore, and the second portion of the cavity is a lower portion of the bore. In some other embodiments, the first portion of the cavity is disposed partially within the bore in the intermediate layer (e.g., within a chamfer segment of the bore corresponding to a chamfer surface of the cavity) and partially outside the bore.

In some embodiments, liquid lens 100 comprises a common electrode 124 in electrical communication with first liquid 106. Additionally, or alternatively, liquid lens 100 comprises a driving electrode 126 disposed on a sidewall of cavity 104 and insulated from first liquid 106 and second liquid 108. Different voltages can be supplied to common electrode 124 and driving electrode 126 (e.g., different potentials can be supplied between the common electrode and the driving electrode) to change the shape of interface 110 as described herein.

In some embodiments, liquid lens 100 comprises a conductive layer 128, at least a portion of which is disposed within cavity 104 (or the bore in intermediate layer 120) and/or defines at least a portion of the sidewall of the cavity. For example, conductive layer 128 comprises a conductive coating applied to intermediate layer 120 prior to bonding first outer layer 118 and/or second outer layer 122 to the intermediate layer. Conductive layer 128 can comprise a metallic material, a conductive polymer material, another suitable conductive material, or a combination thereof. Additionally, or alternatively, conductive layer 128 can comprise a single layer or a plurality of layers, some or all of which can be conductive. In some embodiments, conductive layer 128 defines common electrode 124 and/or driving electrode 126. Conductive layer 128 can be patterned during or after application to intermediate layer 120. For example, conductive layer 128 can be applied to substantially the entire outer surface of intermediate layer 120 prior to bonding first outer layer 118 and/or second outer layer 122 to the intermediate layer. Following application of conductive layer 128 to intermediate layer 118, the conductive layer can be segmented into various conductive elements (e.g., common electrode 124, driving electrode 126, and/or other electrical devices). In some embodiments, liquid lens 100 comprises a scribe 130A in conductive layer 128 to isolate (e.g., electrically isolate) common electrode 124 and driving electrode 126 from each other. For example, scribe 130A can be formed by a photolithographic process, a laser process (e.g., laser ablation), or another suitable scribing process. In some embodiments, scribe 130A comprises a gap in conductive layer 128. For example, scribe 130A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

Although conductive layer 128 is described in reference to FIG. 1 as being segmented following application to intermediate layer 120, other embodiments are included in this disclosure. For example, in some embodiments, the conductive layer is patterned during application to the intermediate layer. For example, a mask can be applied to the intermediate layer prior to applying the conductive layer such that, upon application of the conductive layer, masked regions of the intermediate layer covered by the mask correspond to the gaps in the conductive layer, and upon removal of the mask, the gaps are formed in the conductive layer.

In some embodiments, liquid lens 100 comprises an insulating layer 132 disposed within cavity 104. For example, insulating layer 132 comprises an insulating coating applied to intermediate layer 120 prior to bonding first outer layer 118 and/or second outer layer 122 to the intermediate layer. In some embodiments, insulating layer 132 comprises an insulating coating applied to conductive layer 128 and second window 116 after bonding second outer layer 122 to intermediate layer 120 and prior to bonding first outer layer 118 to the intermediate layer. Thus, insulating layer 132 covers at least a portion of conductive layer 128 within cavity 104 (e.g., driving electrode 126) and second window 116. In some embodiments, insulating layer 132 can be sufficiently transparent to enable passage of image light through second window 116 as described herein. Insulating layer 132 can comprise polytetrafluoroethylene (PTFE), parylene, another suitable polymeric or non-polymeric insulating material, or a combination thereof. Additionally, or alternatively, insulating layer 132 comprises a hydrophobic material. Additionally, or alternatively, insulating layer 132 can comprise a single layer or a plurality of layers, some or all of which can be insulating and/or hydrophobic.

In some embodiments, insulating layer 132 covers at least a portion of driving electrode 126 (e.g., the portion of the driving electrode disposed within cavity 104) to insulate first liquid 106 and second liquid 108 from the driving electrode. Additionally, or alternatively, at least a portion of common electrode 124 disposed within cavity 104 is uncovered by insulating layer 132. Thus, common electrode 124 can be in electrical communication with first liquid 106 as described herein. In some embodiments, insulating layer 128 can fill scribe 130A (e.g., the gap in conductive layer 128) as shown in FIG. 1, which can help to electrically isolate common electrode 124 and driving electrode 126 from each other. In some embodiments, insulating layer 132 forms a sidewall of at least a portion of cavity 104 (e.g., second portion 104B of the cavity and/or an operating portion of the cavity as describe herein). For example, insulating layer 132 comprises a hydrophobic surface layer of at least a portion of cavity 104. Such a hydrophobic surface layer can help to maintain second liquid 108 within second portion 104B of cavity 104 (e.g., by attraction between the non-polar second liquid and the hydrophobic material) and/or enable the perimeter of interface 110 to move along the hydrophobic surface layer (e.g., by electrowetting) to change the shape of the interface as described herein.

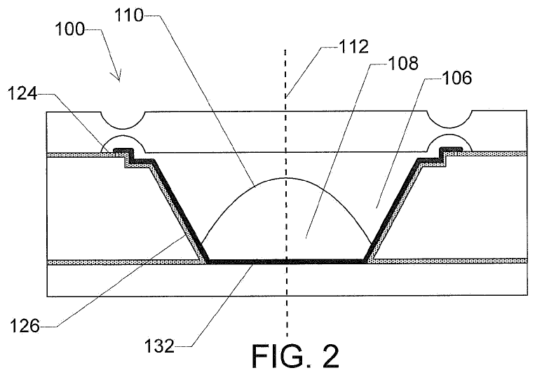

In some embodiments, adjusting interface 110 changes the shape of the interface, which changes the focal length or focus of liquid lens 100. FIG. 2 is a cross-sectional schematic view of liquid lens 100 with an adjusted focal length or focus compared to FIG. 1. For example, the voltage or potential between driving electrode 126 and common electrode 124 can be increased to increase the wettability of insulating layer 132 with respect to first liquid 106, thereby driving the first liquid farther down the sidewall and causing interface 110 to change shape. In some embodiments, the refractive index of first liquid 106 is less than the refractive index of second liquid 108 such that increasing the convex curvature of interface 110 as shown in FIG. 2 increases the optical power of liquid lens 100. In some embodiments, decreasing the voltage can move interface 110 in the opposite direction to decrease the optical power of liquid lens 100. For example, interface 110 can be moved in the opposite direction until the interface becomes flat (e.g., no optical power) or even concave (e.g., negative optical power). In some embodiments, the change in shape of interface 110 can be symmetrical about structural axis 112, thereby changing the focal length of liquid lens 100. Such a change of focal length can enable liquid lens 100 to perform an autofocus function.

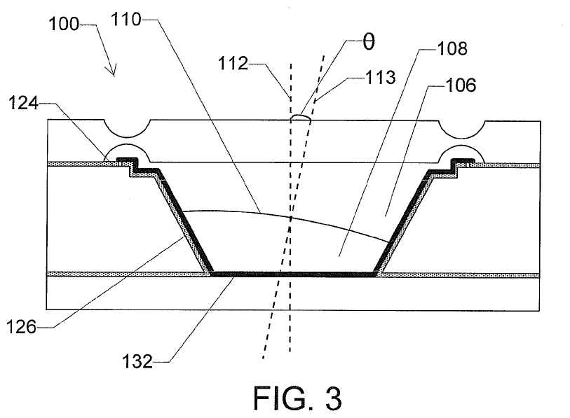

In some embodiments, adjusting interface 110 tilts the interface relative to structural axis 112 of liquid lens 100. FIG. 3 is a cross-sectional schematic view of liquid lens 100 with an adjusted tilt compared to FIG. 1. For example, the voltage between a first portion of driving electrode 126 (e.g., a third driving electrode segment 126C as described herein, positioned on a right side of cavity 104) and common electrode 124 can be increased to increase the wettability of insulating layer 132 with respect to first liquid 106, thereby driving the first liquid farther down the sidewall on one side of the cavity, while the voltage between a second portion of the driving electrode opposite the first portion of the driving electrode (e.g., a first driving electrode segment 126A as described herein, positioned on a left side of the cavity) and the common electrode can be decreased to decrease the wettability of the insulating layer with respect to the first liquid, thereby driving the first liquid farther up the sidewall on an opposite side of the cavity. Following such a change in shape of interface 110, a physical tilt angle θ can be formed between an optical axis 113 of the interface and structural axis 112. For example, optical axis 113 of the tilted interface 110 can be angled relative to structural axis 112 at physical tilt angle θ. An optical tilt angle of liquid lens 100 can be determined based on physical tilt angle θ and the difference in refractive index between first liquid 106 and second liquid 108. The optical tilt angle can be representative of a degree to which interface 110 can refract and/or redirect light passing through liquid lens 100. Such tilting can enable liquid lens 100 to perform an optical image stabilization (OIS) function. Adjusting interface 110 can be achieved without physical movement of liquid lens 100 relative to an image sensor, a fixed lens or lens stack, a housing, or other components of a camera module in which the liquid lens can be incorporated.

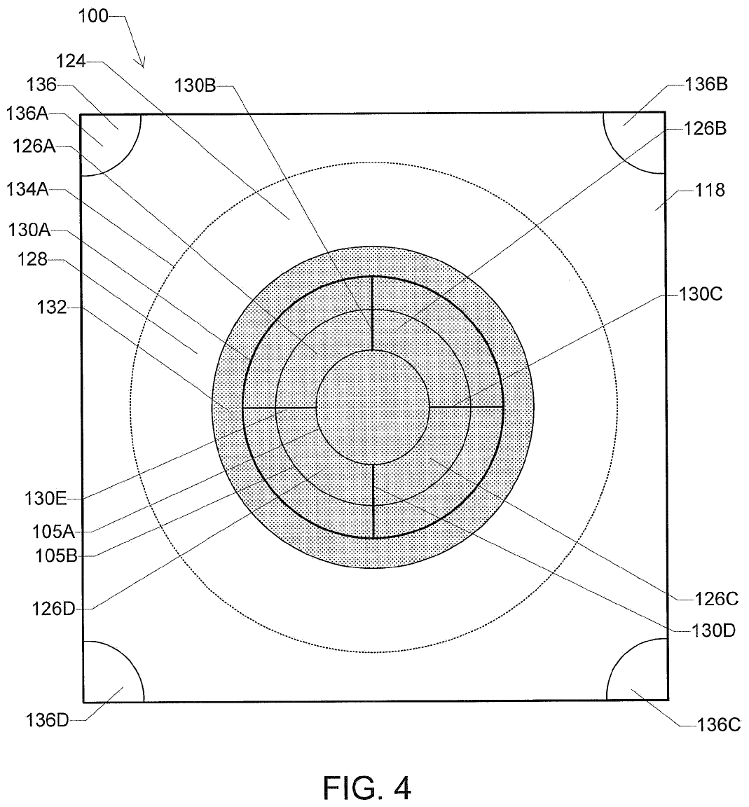

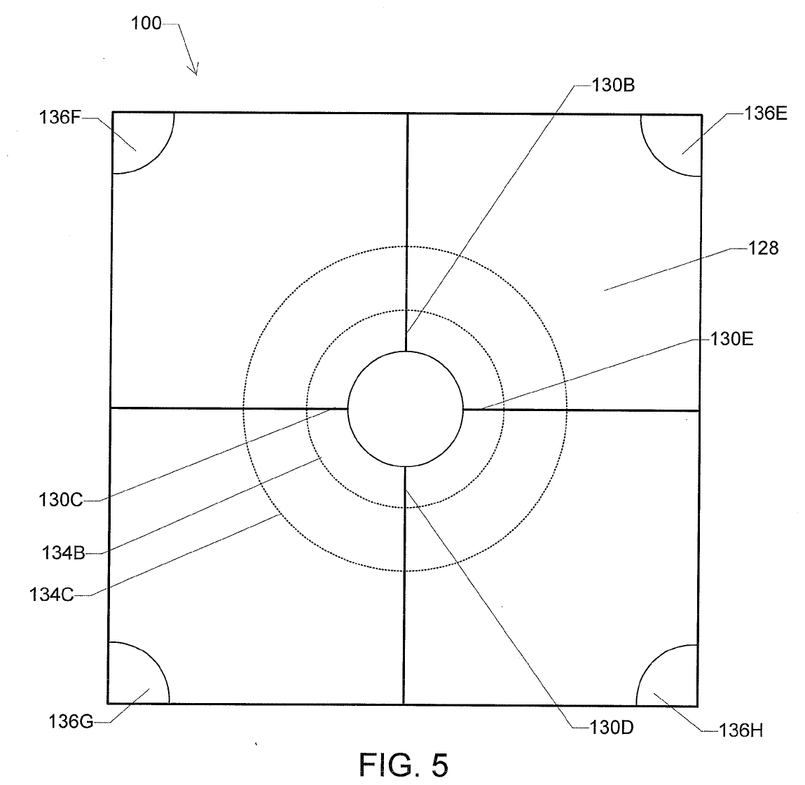

FIG. 4 is a schematic front view of liquid lens 100 looking through first outer layer 118, and FIG. 5 is a schematic rear view of the liquid lens looking through second outer layer 122. For clarity in FIGS. 4 and 5, and with some exceptions, bonds generally are shown in dashed lines, scribes generally are shown in heavier lines, and other features generally are shown in lighter lines.

In some embodiments, common electrode 124 is defined between scribe 130A and an outer edge of liquid lens 100. A portion of common electrode 124 can be uncovered by insulating layer 132 such that the common electrode can be in electrical communication with first liquid 106 as described herein. In some embodiments, bond 134A is configured such that electrical continuity is maintained between the portion of conductive layer 128 inside the bond (e.g., inside cavity 104 and/or between the bond and scribe 130A) and the portion of the conductive layer outside the bond (e.g., outside the cavity). In some embodiments, liquid lens 100 comprises one or more cutouts 136 in first outer layer 118. For example, in the embodiments shown in FIG. 4, liquid lens 100 comprises a first cutout 136A, a second cutout 136B, a third cutout 136C, and a fourth cutout 136D. In some embodiments, cutouts 136 comprise portions of liquid lens 100 at which first outer layer 118 is removed to expose conductive layer 128. Thus, cutouts 136 can enable electrical connection to common electrode 124, and the regions of conductive layer 128 exposed at the cutouts can serve as contacts to enable electrical connection of liquid lens 100 to a controller, a driver, or another component of a lens or camera system.

Although cutouts 136 are described herein as being positioned at corners of liquid lens 100, other embodiments are included in this disclosure. For example, in some embodiments, one or more of the cutouts are disposed inboard of the outer perimeter of the liquid lens and/or along one or more edges of the liquid lens.

In some embodiments, driving electrode 126 comprises a plurality of driving electrode segments. For example, in the embodiments shown in FIGS. 4 and 5, driving electrode 126 comprises a first driving electrode segment 126A, a second driving electrode segment 126B, a third driving electrode segment 126C, and a fourth driving electrode segment 126D. In some embodiments, the driving electrode segments are distributed substantially uniformly about the sidewall of cavity 104. For example, each driving electrode segment occupies about one quarter, or one quadrant, of the sidewall of second portion 104B of cavity 104. In some embodiments, adjacent driving electrode segments are isolated from each other by a scribe. For example, first driving electrode segment 126A and second driving electrode segment 126B are isolated from each other by a scribe 130B. Additionally, or alternatively, second driving electrode segment 126B and third driving electrode segment 126C are isolated from each other by a scribe 130C. Additionally, or alternatively, third driving electrode segment 126C and fourth driving electrode segment 126D are isolated from each other by a scribe 130D. Additionally, or alternatively, fourth driving electrode segment 126D and first driving electrode segment 126A are isolated from each other by a scribe 130E. The various scribes 130 can be configured as described herein in reference to scribe 130A. In some embodiments, the scribes between the various electrode segments extend beyond cavity 104 and onto the back side of liquid lens 100 as shown in FIG. 5. Such a configuration can ensure electrical isolation of the adjacent driving electrode segments from each other. Additionally, or alternatively, such a configuration can enable each driving electrode segment to have a corresponding contact for electrical connection as described herein.

Although driving electrode 126 is described herein as being divided into four driving electrode segments, other embodiments are included in this disclosure. In some other embodiments, the driving electrode comprises a single driving electrode (e.g., substantially circumscribing the sidewall of the cavity). For example, the liquid lens comprising such a single driving electrode can be capable of varying focal length, but incapable of tilting the interface (e.g., an autofocus only liquid lens). In some other embodiments, the driving electrode is divided into two, three, five, six, seven, eight, or more driving electrode segments (e.g., distributed substantially uniformly about the sidewall of the cavity).

In some embodiments, bond 134B and/or bond 134C are configured such that electrical continuity is maintained between the portion of conductive layer 128 inside the respective bond and the portion of the conductive layer outside the respective bond. In some embodiments, liquid lens 100 comprises one or more cutouts 136 in second outer layer 122. For example, in the embodiments shown in FIG. 5, liquid lens 100 comprises a fifth cutout 136E, a sixth cutout 136F, a seventh cutout 136G, and an eighth cutout 136H. In some embodiments, cutouts 136 comprise portions of liquid lens 100 at which second outer layer 122 is removed to expose conductive layer 128. Thus, cutouts 136 can enable electrical connection to driving electrode 126, and the regions of conductive layer 128 exposed at cutouts 136 can serve as contacts to enable electrical connection of liquid lens 100 to a controller, a driver, or another component of a lens or camera system.

Different driving voltages can be supplied to different driving electrode segments to tilt the interface of the liquid lens (e.g., for OIS functionality). Additionally, or alternatively, a driving voltage can be supplied to a single driving electrode or the same driving voltage can be supplied to each driving electrode segment to maintain the interface of the liquid lens in a substantially spherical orientation about the structural axis (e.g., for autofocus functionality) and/or to maintain the optical axis in alignment with the structural axis.

In some embodiments, first outer layer 118 comprises a peripheral portion 118A, a central portion 118B, and a recess portion 118C disposed between the peripheral portion and the central portion as shown in FIG. 1. For example, peripheral portion 118A is disposed laterally outboard (or farther from structural axis 112) of central portion 118B, with recess portion 118C disposed between the peripheral portion and the central portion. In some embodiments, central portion 118B comprises first window 114. For example, central portion 118B at least partially overlies cavity 104, whereby at least a portion of the central portion of first outer layer 118 serves as first window 114. In some embodiments, peripheral portion 118A of first outer layer 118 is bonded to intermediate layer 120 (e.g., at bond 134A) as described herein. In some embodiments, first outer layer 118 comprises a monolithic or unitary body (e.g., formed from a single piece of material such as, for example, a glass substrate). For example, each of peripheral portion 118A, central portion 118B, and recess portion 118C is part of the monolithic first outer layer 118.

In some embodiments, recess 119 is formed or disposed in recess portion 118C as shown in FIG. 1. For example, recess 119 comprises a depression or channel formed in a surface of first outer layer 118. Additionally, or alternatively, recess 119 comprises an annular recess. In some embodiments, the annular recess at least partially circumscribes first window 114 and/or cavity 104 as shown in FIG. 1. For example, the annular recess encircles and/or partially overlaps lip 107 of cavity 104. In some embodiments, recess 119 comprises a first recess 119A (e.g., an interior recess) and a second recess 119B (e.g., an exterior recess). For example, first recess 119A is disposed on and/or formed in an interior surface of first outer layer 118. Additionally, or alternatively, second recess 119B is disposed on and/or formed in an exterior surface of first outer layer 118. In some embodiments, first recess 119A and second recess 119B define a thinned region of first outer layer 118 disposed between the first recess and the second recess. For example, first recess 119A and second recess 119B are at least partially aligned or overlapping (e.g., in an axial direction parallel or substantially parallel to structural axis 112) such that a portion of first outer layer 118 disposed between (e.g., axially between) the first recess and the second recess defines the thinned region of the first outer layer. The thinned region can define a flexure 121 as described herein. For example, the thinned region can have a lower stiffness than peripheral portion 118A and/or central portion 118B of first outer layer 118, which can enable first window 114 to move (e.g., translate axially) as described herein. In some embodiments, first recess 119A and/or second recess 119B comprise annular recesses. Thus, the thinned region disposed between first recess 119A and second recess 119B can comprise an annular thinned region, which can at least partially circumscribe first window 114 and/or cavity 104. In some embodiments, first recess 119A defines a portion of cavity 104. For example, first recess 119A is in communication with the bore in intermediate layer 120 as shown in FIG. 1 such that the bore and the first recess cooperatively define cavity 104.

Although first recess 119A and second recess 119B shown in FIG. 1 have a semi-circular cross-sectional shape, other embodiments are included in this disclosure. In some embodiments, the recess can have a triangular, rectangular, semi-elliptical, or other complete or partial polygonal or non-polygonal cross-sectional shape. Additionally, or alternatively, the first recess and the second recess can have the same or different cross-sectional shapes and the same or different sizes. Additionally, or alternatively, the first recess and/or the second recess can comprise multiple recesses (e.g., a plurality of concentric recesses).

In some embodiments, recess portion 118C of first outer layer 118 enables first window 114 to translate relative to peripheral portion 118A in the axial direction. For example, the reduced stiffness of the thinned region of first outer layer 118 compared to peripheral portion 118A and/or central portion 118B can enable the first outer layer to flex or bend at the thinned region. Such flexing or bending can be caused, for example, by expansion or contraction of first liquid 106 and/or second liquid 108 within cavity 104 (e.g., as a result of an increase or decrease in temperature), by physical shock to first outer layer 118, or by another force exerted on the first outer layer (e.g., from inside or outside the cavity). The relatively high stiffness of central portion 118B can help to prevent first window 114 from flexing or bowing as the first window translates, which can prevent a change in optical power (e.g., focal length or focus) of liquid lens 100 resulting from a change in curvature of the first window.

In some embodiments, recess portion 118C of first outer layer 118 helps to avoid contact between central portion 118B and/or the thinned region of first outer layer 118 with intermediate layer 120 upon translation of first window 114. For example, upon flexing or bending of first outer layer 118 (e.g., in a downward axial direction or toward cavity 104), lip 107 of the cavity can be received within recess 119, thereby avoiding central portion 118B and/or the thinned region of first outer layer 118 contacting or bottoming out on intermediate layer 120.

In some embodiments, a thickness of peripheral portion 118A of first outer layer 118 is substantially the same as a thickness of central portion 118B and/or first window 114. Such a relatively thick central portion 118B and/or first window 114 can be enabled, for example, by recess 119 (e.g., receiving lip 107 of cavity 104 within the recess as described herein). Additionally, or alternatively, a substantially uniform thickness of peripheral portion 118A and central portion 118B and/or first window 114, can enable first outer layer 118 to be formed from a substantially planar sheet of material without thinning the central portion and/or the first window (e.g., without etching, grinding, or polishing the central portion and/or the first window to reduce the thickness thereof). Avoiding such a thinning step can help to maintain the surface quality of first window 114, which can improve the image quality of liquid lens 100 compared to liquid lenses with thinned window regions. Additionally, or alternatively, avoiding such a thinning step can reduce the number of steps involved in manufacturing first outer layer 118 compared to liquid lenses with thinned window regions, thereby simplifying production of liquid lens 100.

In some embodiments, insulating layer 132 wraps around lip 107 of cavity 104. For example, at least a portion of an edge 133 of insulating layer 132 is disposed within recess 119 as shown in FIG. 1. Edge 133 can be a peripheral outer edge of insulating layer 132. In some embodiments, an exposed portion of common electrode 124 disposed laterally between (e.g., in a lateral direction perpendicular or substantially perpendicular to structural axis 112) edge 133 of insulating layer 132 and peripheral portion 118A of first outer layer 118 (e.g., laterally outboard of the edge of the insulating layer) is in electrical communication with first liquid 106. For example, the exposed portion of common electrode 124 is disposed within recess 119 (e.g., first recess 119A) and in electrical communication with first liquid 106 via a portion of the first liquid disposed within the recess.

In some embodiments, recess 119 enables insulating layer 132 to wrap around lip 107 of cavity 104 while maintaining a gap between the insulating layer and first outer layer 118. Such a gap can enable a portion of first liquid 106 to occupy recess 119, thereby enabling electrical communication between the exposed portion of common electrode 124 and the bulk of the first liquid via the portion of the first liquid disposed in the recess. For example, at least a portion of recess 119 (e.g., first recess 119A) can define first portion 104A of cavity 104, which can be occupied by first liquid 106 to maintain electrical communication between common electrode 124 and the bulk of the first liquid (e.g., disposed outside of the recess and/or in second portion 104B of the cavity). Additionally, or alternatively, such a gap can enable the substantially uniform thickness of peripheral portion 118A and central portion 118B and/or first window 114 as described herein (e.g., because the gap can be maintained without thinning the central portion and/or the first window).

In some embodiments, cavity 104 comprises a sidewall 140 (e.g., a sidewall surface) extending between first outer layer 118 and second window 116. For example, sidewall 140 is defined by the bore in intermediate layer 120 (e.g., a wall of the bore), conductive layer 128 (e.g., a portion of the conductive layer disposed on a portion of the wall of the bore), and/or insulating layer 132 (e.g., a portion of the insulating layer disposed on the conductive layer). In some embodiments, sidewall 140 is straight (e.g., along the sidewall in the axial direction). For example, the deviation of sidewall 140 from linear, measured along an entire height of the sidewall in the axial direction, is at most about 50 μm, at most about 40 μm, at most about 30 μm, at most about 20 μm, at most about 10 μm, at most about 5 μm, or any ranges defined by the listed values.

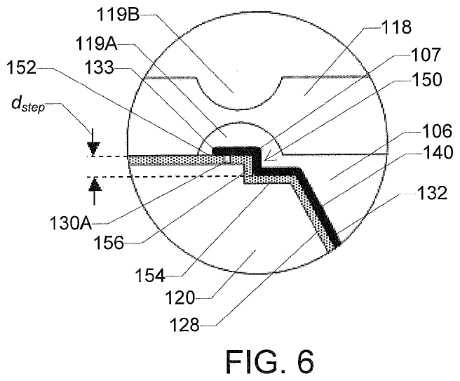

In some embodiments, cavity 104 comprises a step 150 disposed between (e.g., axially between) sidewall 140 and first outer layer 118. FIG. 6 is a close-up view of a portion of liquid lens 100 shown in FIG. 1. In some embodiments, step 150 comprises a first tread portion 152, a second tread portion 154, and a riser portion 156 disposed between the first tread portion and the second tread portion as shown in FIG. 6. For example, first tread portion 152 and/or second tread portion 154 are disposed at least partially in a lateral orientation (e.g., extending at least partially in the lateral direction). In some embodiments, first tread portion 152 and/or second tread portion 154 are disposed perpendicular or substantially perpendicular to structural axis 112 as shown in FIG. 6. In other embodiments, the first tread portion and/or the second tread portion are disposed at a non-perpendicular or oblique angle to the structural axis. Additionally, or alternatively, riser portion 156 is disposed at least partially in an axial orientation (e.g., extending at least partially in the axial direction). In some embodiments, riser portion 156 is disposed parallel or substantially parallel to structural axis 112 as shown in FIG. 6. In other embodiments, the riser portion is disposed at a non-parallel or oblique angle to the structural axis. In some embodiments, second tread portion 154 is offset from first tread portion 152 in the axial direction. For example, second tread portion 154 is axially offset from first tread portion by a distance dₛₜₑₚ. Additionally, or alternatively, riser portion 156 adjoins each of first tread portion 152 and second tread portion 154 such that the first tread portion, the riser portion, and the second tread portion cooperatively define a contiguous step. In some embodiments, the distance dₛₜₑₚ is substantially equal to a height of riser portion 156 of step 150.

In some embodiments, riser portion 156 is aligned (e.g., axially aligned) with recess portion 118C of first outer layer 118. Such alignment can enable insulating layer 132 to wrap around lip 107 of cavity 104 as described herein. For example, in some embodiments, at least a portion of edge 133 of insulating layer 132 is disposed on first tread portion 152 of step 150 and within recess 119 (e.g., first recess 119A) of first outer layer 118 as shown in FIGS. 1 and 6. Additionally, or alternatively, such alignment can enable first outer layer 118 to flex as described herein.

In some embodiments, sidewall 140 comprises a straight portion of cavity 104 and/or step 150 comprises a peripheral notch formed in a portion of the cavity (e.g., an upper portion of the cavity adjacent first outer layer 118) as shown in FIGS. 1 and 6. For example, step 150 comprises an annular notch or cutout disposed at an upper peripheral portion of the bore in intermediate layer 120 between sidewall 140 and first outer layer 118. In some embodiments, step 150 can enable the gap to be maintained between intermediate layer 120 and first outer layer 118. For example, the interior surface of central portion 118B and/or first window 114 is spaced from second tread portion 154 of step 150 by a distance (e.g., the distance dₛₜₑₚ), which can be measured with the first outer layer in a planar configuration (e.g., with peripheral portion 118A and the central portion substantially aligned in a common plane). Such a gap can enable translation of central portion 118B and/or window 114 as described herein. Additionally, or alternatively, such a gap can enable insulating layer 132 to wrap around lip 107 as described herein.

In some embodiments, step 150 is implemented in combination with recess 119 as shown in FIGS. 1 and 6. In some of such embodiments, a transition between first tread portion 152 and riser portion 156 defines lip 107. In some embodiments, step 150 can be implemented without recess 119. In some embodiments, a transition between sidewall 140 and step 150 (e.g., second tread portion 154 of the step) defines the lip of the cavity. Such a configuration can enable the recess in the first outer layer (e.g., first recess 119A) to be omitted. For example, in some embodiments, scribe 130A in conductive layer 128 and edge 133 of insulating layer 132 are disposed, independently, on second tread portion 154 or riser portion 156 of step 150. Thus, insulating layer 132 wraps around the lip of cavity 104, and a portion of common electrode 124 (e.g., the exposed portion of the common electrode) disposed on second tread portion 154 or riser portion 156 can be exposed to enable electrical communication with first liquid 106 as described herein.

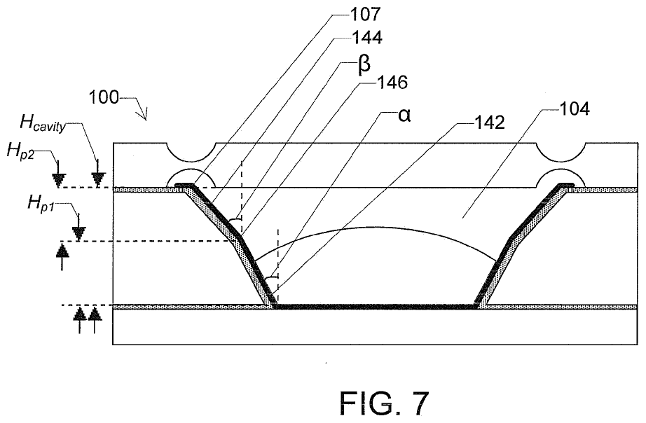

FIG. 7 is a schematic cross-sectional view of some embodiments of liquid lens 100. Liquid lens 100 shown in FIG. 7 is similar to the liquid lens described in reference to FIGS. 1-6, and the common features described herein in connection with FIGS. 1-6 may not be repeated in connection with FIG. 7. In some embodiments, sidewall 140 of cavity 104 comprises a first portion 142, a second portion 144 disposed between the first portion of the sidewall and first outer layer 118, and a transition 146 disposed between the first portion of the sidewall and the second portion of the sidewall. In some embodiments, first portion 142 of sidewall 140 is disposed and/or extends at an angle α to structural axis 112. Additionally, or alternatively, second portion 144 of sidewall 140 is disposed and/or extends at an angle β to structural axis 112. In some embodiments, first portion 142 of sidewall 140 and/or second portion 144 of the sidewall are straight portions. For example, the deviation of first portion 142 of sidewall 140 and/or second portion 144 of the sidewall from linear, measured along an entire height of the respective portion of the sidewall in the axial direction, is, independently, at most about 50 μm, at most about 40 μm, at most about 30 μm, at most about 20 μm, at most about 10 μm, at most about 5 μm, or any ranges defined by the listed values.

In some embodiments, sidewall 140 comprises a multi-angle sidewall comprising a plurality of sidewall portions or segments (e.g., first portion 142 and second portion 144) disposed at different orientations or angles relative to structural axis 112. In some embodiments, sidewall 140 comprises a radiused interface (e.g., transition 146) between adjacent segments. In some embodiments, angle α is smaller than angle β as shown in FIG. 7. For example, cavity 104 comprises a flared cavity in which the angle of sidewall 140 is greater near lip 107 of the cavity (e.g., proximate first outer layer 118 and/or first window 114) than near a floor of the cavity (e.g., proximate second window 116). Thus, the flared cavity can be wider near the lip of the cavity and narrower near the floor of the cavity. In other embodiments, angle α is larger than angle β. In some embodiments, angle α and/or angle β are, independently, about 0°, about 5°, about 10°, about 15°, about 20°, about 25°, about 30°, about 35°, about 40°, about 45°, about 50°, or any ranges defined by the listed values. Additionally, or alternatively, a difference between angle α and angle β is at least about 5°, at least about 10°, at least about 15°, at least about 20°, at least about 25°, at least about 30°, at least about 35°, at least about 40°, at least about 45°, or any ranges defined by the listed values.

In some embodiments, a cavity height H_{cavity} is an axial distance between a ceiling of cavity 104 (e.g., an interior surface of first window 114) and a floor of the cavity (e.g., an interior surface of second window 116 or a portion of insulating layer 132 disposed on the second window). For example, cavity height H_{cavity} can be measured with first outer layer 118 in the planar configuration. In some embodiments, a height Hₚ₁ of first portion 142 of sidewall 140 (e.g., an axial height of the first portion of the sidewall) is about 30% to about 70% of cavity height H_{cavity}. Additionally, or alternatively, a height Hₚ₂ of second portion 144 of sidewall 140 (e.g., an axial height of the second portion of the sidewall) is about 30% to about 70% of cavity height H_{cavity}. For example, height Hₚ₁ and/or height Hₚ₂ are, independently, about 30%, about 35%, about 40%, about 45%, about 50%, about 55%, about 60%, about 65%, about 70% of cavity height H_{cavity}, or any ranges defined by the listed values. In some embodiments, cavity height H_{cavity} is about 0.5 mm, about 0.55 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, or any ranges defined by the listed values. Additionally, or alternatively, height Hₚ₁ and/or height Hₚ₂ are, independently, about 0.1 mm, about 0.2 mm, about 0.3 mm, about 0.35 mm, about 0.4 mm, about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, or any ranges defined by the listed values.

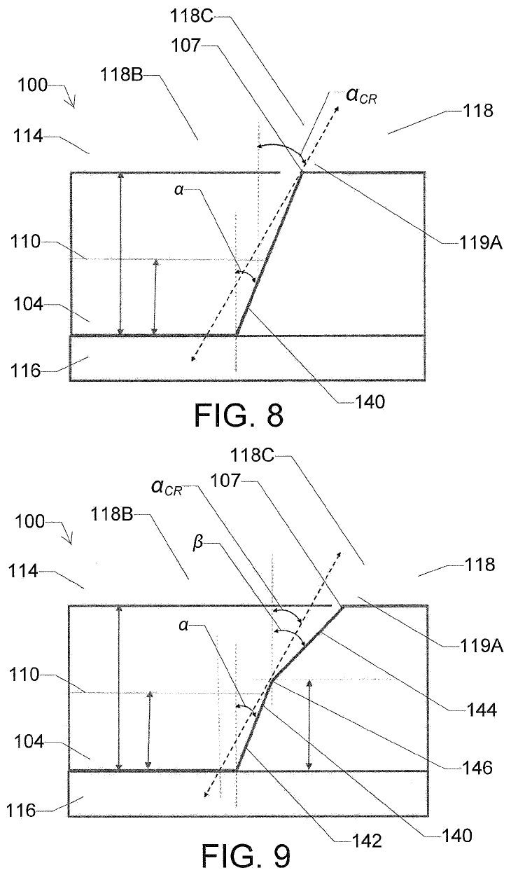

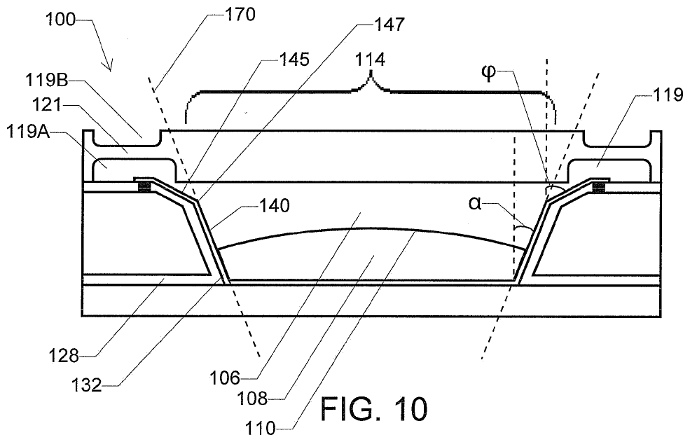

In some embodiments, angle α, angle β, cavity height H_{cavity}, height Hₚ₁, and height Hₚ₂ can be determined to enable liquid lens 100 to exhibit an improvement in one or more of chief ray angle, clear aperture, and/or performance (e.g., image quality and/or response time), while maintaining the others of the listed parameters. FIG. 8 is a schematic cross-sectional view of some embodiments of liquid lens 100 without a multi-angle cavity sidewall, and FIG. 9 is a schematic cross-sectional view of some embodiments of the liquid lens comprising the multi-angle sidewall described herein. It should be noted that FIGS. 8-9 show half of liquid lenses 100, as opposed to entire cross-sections of the liquid lenses. In some embodiments, the other halves of the liquid lenses (e.g., the halves of the liquid lenses not shown in FIGS. 8-9) can be mirror images of the halves shown in FIGS. 8-9. Additionally, for clarity, conductive layer 128 and insulating layer 132 are omitted from FIGS. 8-9. Angle α of sidewall 140 of liquid lens 100 shown in FIG. 8 is less than chief ray angle α_{CR} of the liquid lens, which can represent a ray that passes through the center of the aperture stop at a particular field of view. Accordingly, lip 107 of cavity 104 can serve as the aperture stop of liquid lens 100, and an outermost ray that passes through first outer layer 118 of the liquid lens at chief ray angle α_{CR} and/or at an edge of the field of view also can pass through recess portion 118C of first outer layer 118 (e.g., because the recess can be positioned so that the lip is axially aligned with the recess portion as described herein), which can add optical aberrations at the edges of the resulting image (e.g., as a result of refraction caused by curved surfaces of the recess and/or distortion caused by rough surfaces of the recess). In contrast, sidewall 140 of liquid lens 100 shown in FIG. 9 comprises first portion 142 with angle a that is less than chief ray angle α_{CR} and second portion 144 with angle β that is greater than the chief ray angle. Accordingly, transition 146 of cavity 104 can serve as the aperture stop of liquid lens 100 as opposed to lip 107. Additionally, or alternatively, an outermost ray that passes through first outer layer 118 of liquid lens 100 at chief ray angle α_{CR} and/or at an edge of the field of view may pass through second window 116 as opposed to recess portion 118C of the first outer layer, which can help to avoid optical aberrations at the edges of the resulting image. For example, angle β and/or height Hₚ₂ can be sufficiently large that the outermost ray that passes through first outer layer 118 of liquid lens 100 at chief ray angle α_{CR} and/or at an edge of the field of view may pass through central portion 118B of first outer layer 118 and/or first window 114, and not through recess 119.

In some embodiments, the flared cavity of the liquid lens can enable the aperture stop to be moved axially away from the first window toward the second window, which can help to improve the image quality of the liquid lens while maintaining the chief ray angle or field of view and/or increase the chief ray angle or field of view while maintaining the clear aperture of the liquid lens. Additionally, or alternatively, the flared cavity can enable the liquid lens to exhibit improved performance without sacrificing chief ray angle α_{CR} or field of view and/or clear aperture. For example, angle α and/or height Hₚ₁ can be configured to enable a determined chief ray angle α_{CR} or field of view and/or clear aperture, while angle β and height Hₚ₂ can be configured to improve the dynamic performance (e.g., response time and/or speed) of liquid lens 100 and/or improve image quality. In some embodiments, a ratio of a volume of an upper portion of cavity 104 defined by second portion 144 of sidewall 140, to a total volume of the cavity is about 0.4 to about 0.6.

In some embodiments, transition 146 comprises a curved or rounded interface between first portion 142 of sidewall 140 and second portion 144 of the sidewall as shown in FIG. 7. Transition 146 can have a radius of curvature that is sufficiently large that interface 110 is capable of passing over the transition during operation of liquid lens 100. For example, in some embodiments, when liquid lens 100 is in a zero optical power configuration (e.g., with interface 110 in a flat or substantially flat configuration as shown in FIGS. 8-9), the perimeter of the interface (e.g., the annular intersection of the interface with insulating layer 132) can be disposed on or adjacent first portion 142 of sidewall 140 (e.g., below transition 146 and/or between the transition and second window 116). In some of such embodiments, causing the perimeter of the interface to move toward first outer layer 118 and/or first window 114 (e.g., by reducing the voltage between common electrode 124 and driving electrode 126) can cause the perimeter to move over transition 146 and onto or adjacent second portion 144 of sidewall 140 (e.g., above the transition and/or between the transition and the first outer layer and/or the first window). For example, reducing the voltage between common electrode 124 and driving electrode 126 (e.g., to a zero voltage and/or a minimum operating voltage) can cause the perimeter of the interface to move over transition 146 as described herein. Additionally, or alternatively, causing the perimeter of the interface to move back toward second window 116 (e.g., by increasing the voltage between common electrode 124 and driving electrode 126) can cause the perimeter to move over transition 146 and onto or adjacent first portion 142 of sidewall 140 (e.g., below the transition and/or between the transition and the second window). For example, increasing the voltage between common electrode 124 and driving electrode 126 (e.g., to a maximum operating voltage) can cause the perimeter of the interface to move over transition 146 as described herein. The radius of curvature of transition 146 can be sufficiently large to enable such movement of interface 110 (e.g., to enable liquid lens 100 to be moved between relatively large negative optical power and positive optical power configurations). For example, transition 146 can be disposed within an operating portion of sidewall 140 over which the perimeter of the interface passes in response to adjusting the operating voltage of liquid lens 100 from the minimum operating voltage to the maximum operating voltage (or from the maximum operating voltage to the minimum operating voltage), whereby the perimeter of the interface crosses over the transition upon operating the liquid lens over the operating voltage range between the minimum operating voltage and the maximum operating voltage. In some embodiments, transition 146 can be sufficiently blunt to prevent trapping interface 110 on one side of the transition, thereby preventing movement of the interface over the transition. In some embodiments, transition 146 has a radius of curvature of at least 100 μm, at least 110 μm, at least 120 μm, at least 130 μm, at least 140 μm, at least 150 μm, at least 160 μm, at least 170 μm, at least 180 μm, at least 190 μm, at least 200 μm, at least 210 μm, at least 220 μm, at least 230 μm, at least 240 μm, at least 250 μm, at least 260 μm, at least 270 μm, at least 280 μm, at least 290 μm, at least 300 μm, at least 350 μm, at least 400 μm, at least 500 μm, or any ranges defined by the listed values.

Although the perimeter of interface 110 of liquid lens 100 shown in FIGS. 8-9 in the zero optical power configuration is disposed on or adjacent first portion 142 of sidewall 140, other embodiments are included in this disclosure. For example, in some embodiments, when liquid lens 100 is in a zero optical power configuration, the perimeter of the interface can be disposed on or adjacent second portion 144 of sidewall 140. In some of such embodiments, transition 146 can be configured to enable the perimeter of interface 110 to pass over the transition as described herein.

In some embodiments, the multi-angle sidewall 140 is implemented in combination with recess 119 and without step 150 as shown in FIG. 7. In other embodiments, any combination of the multi-angle sidewall 140, recess 119 (e.g., having any of the various configurations described herein), and/or step 150 can be implemented.

FIG. 10 is a schematic cross-sectional view of some embodiments of liquid lens 100. Liquid lens 100 shown in FIG. 10 is similar to the liquid lenses described in reference to FIGS. 1-9, and the common features described herein in connection with FIGS. 1-9 may not be repeated in connection with FIG. 10. In some embodiments, recess 119 comprises interior recess 119A and exterior recess 119B. For example, interior recess 119A comprises a notch or channel formed in an interior surface of first outer layer 118. Additionally, or alternatively, exterior recess 119B comprises a notch or channel formed in an exterior surface of first outer layer 118. Interior recess 119A and exterior recess 119B can be at least partially axially aligned, whereby a relatively thin region of first outer layer 118 disposed axially between the interior recess and the exterior recess defines a flexure 121. For example, interior recess 119A and exterior recess 119B can at least partially overlap, whereby a portion of first outer layer 118 disposed between the interior recess and the exterior recess and having a reduced thickness (e.g., relative to central portion 118B, first window 114, and/or peripheral portion 118A of the first outer layer as described herein) defines flexure 121.

In some embodiments, interior recess 119A and/or exterior recess 119B are annular recesses partially or entirely circumscribing first window 114. For example, interior recess 119A and/or exterior recess 119B comprise a circular, triangular, rectangular, or other polygonal or non-polygonal ring shape partially or entirely encircling first window 114. Interior recess 119A and exterior recess 119B can have the same or different cross-sectional shapes. For example, interior recess 119A and exterior recess 119B can have rounded rectangular cross-sectional shapes as shown in FIG. 10 or semi-circular, triangular, rectangular, or other full or partial polygonal or non-polygonal cross-sectional shapes. Additionally, or alternatively, interior recess 119A and/or exterior recess 119B can have a substantially regular (e.g., straight and/or smooth) floor and/or edges as shown in FIG. 10 or an irregular (e.g., ribbed, scalloped, corrugated, and/or roughened) floor and/or edges. The irregular floor and/or edges can help to

In some embodiments, cavity 104 comprises sidewall surface 140. For example, sidewall surface 140 comprises a surface of cavity 104 disposed within the bore in intermediate layer 120. Sidewall surface 140 can comprise an interior surface of cavity 104 disposed at a central region of the bore in intermediate layer 120 and/or proximate second outer layer 122. Sidewall surface 140 can be defined by the material of intermediate layer 120 itself or another layer or material disposed on the intermediate layer. For example, sidewall surface 140 can be defined by one or more of conductive layer 128, insulating layer 132, or another layer disposed within the bore in intermediate layer 120. In some embodiments, different portions of sidewall surface 140 can be defined by the same or different materials or layers. In some embodiments, sidewall surface 140 is angled relative to structural axis 112 at a sidewall angle α as shown in FIG. 10. For example, sidewall surface 140 or a portion thereof comprises a conical or pyramidal shape. Additionally, or alternatively, the sidewall surface can be configured as a multi-angle sidewall surface comprising a plurality of sidewall portions as described herein (e.g., with reference to FIG. 7).

In some embodiments, sidewall surface 140 defines a contact surface in contact with first liquid 106 and/or second liquid 108. The perimeter of interface 110 can be disposed on sidewall surface 140, and the position of the perimeter of the interface can be adjustable along at least a portion of the sidewall surface (e.g., by adjusting the voltage signal supplied to liquid lens 100 as described herein). For example, sidewall surface 140 or a portion thereof comprises an active surface along which the perimeter of interface 110 can be adjusted between a minimum operating voltage and a maximum operating voltage of liquid lens 100. For example, the active surface can correspond to the operating portion of sidewall 140 as described herein.

In some embodiments, cavity 104 comprises a chamfer surface 145. For example, chamfer surface 145 comprises a surface of cavity 104 disposed within the bore in intermediate layer 120. In some embodiments, chamfer surface 145 is disposed between sidewall surface 140 and first outer layer 118. For example, chamfer surface 145 extends between sidewall surface 140 and a peripheral surface of intermediate layer 120 (e.g., a first or upper surface of the intermediate layer circumscribing the bore in the intermediate layer). First outer layer 118 (e.g., peripheral portion 118A) can be bonded to the peripheral surface of intermediate layer 120 as described herein. Chamfer surface 145 can comprise an interior surface of a flared region of cavity 104 disposed at an upper or image side region of the bore in intermediate layer 120 (e.g., proximate lip 107 and/or first outer layer 118). Chamfer surface 145 can be defined by the material of intermediate layer 120 itself or another layer or material disposed on the intermediate layer. Additionally, or alternatively, different portions of chamfer surface 145 can be defined by the same or different materials or layers. In some embodiments, chamfer surface 145 is angled relative to structural axis 112 at a chamfer angle φ, which can be greater than sidewall angle α (and/or sidewall angle β in embodiments comprising a multi-angle sidewall as described herein). For example, chamfer angle φ is 30°, 35°, 40°, 45°, 50°, 55°, 60°, 65°, 70°, 75°, 80°, 85°, 90°, 95°, 100°, 105°, 110°, 115°, 120°, or any ranges defined by the listed values. Additionally, or alternatively, chamfer surface 145 can comprise a conical or pyramidal shape.

In some embodiments, chamfer surface 145 defines a contact surface in contact with first liquid 106, but not second liquid 108. The perimeter of interface 110 can be disposed on and adjustable along sidewall surface 140 as described herein. Chamfer surface 145 can comprise an inactive surface that is not contacted by the perimeter of interface 110 between the minimum operating voltage and the maximum operating voltage of liquid lens 100. For example, upon driving liquid lens 100 with the minimum operating voltage (e.g., a zero voltage), the perimeter of interface 110 can move to a transition 147 between sidewall surface 140 and chamfer surface 145 without moving onto the chamfer surface. In some embodiments, transition 147 comprises a sharp or pointed interface between sidewall surface 140 and chamfer surface 145. In contrast to transition 146 shown in FIG. 7, transition 147 shown in FIG. 10 can have a radius of curvature that is sufficiently small that interface 110 is substantially incapable of passing over the transition during operation of liquid lens 100. For example, in some embodiments, when liquid lens 100 is in a zero optical power configuration, the perimeter of the interface can be disposed on or adjacent sidewall surface 140, and causing the perimeter of the interface to move toward first outer layer 118 and/or first window 114 can cause the perimeter to move to transition 147 without passing onto chamfer surface 145. In some embodiments, transition 147 can be disposed between an active surface of cavity 104 (e.g., sidewall surface 140) and an inactive surface of the cavity (e.g., chamfer surface 145). In some embodiments, transition 147 has a radius of curvature of at most 50 μm, at most 60 μm, at most 70 μm, at most 80 μm, at most 90 μm, at most 100 μm, at most 110 μm, at most 120 μm, at most 130 μm, at most 140 μm, at most 150 μm, or any ranges defined by the listed values.

In some embodiments, sidewall surface 140 and chamfer surface 145 comprise, independently, an axial height of about 0.05 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1 mm, or any ranges defined by the listed values. The axial height of sidewall surface 140 can be greater than or less than the axial height of chamfer surface 145. In some embodiments, a ratio of the axial height of sidewall surface 140 to the axial height of chamfer surface 145 is about 1, 1.1, 1.2, 1.3, 1.4, 1.5, 1.6, 1.7, 1.8, 1.9, 2, 2.1, 2.2, 2.3, 2.4, 2.5, or any ranges defined by the listed values.

In some embodiments, a sidewall projection 170 of sidewall surface 140 comprises an imaginary extension of sidewall surface 140 through first outer layer 118. For example, a three-dimensional space disposed within sidewall projection 170 defines a projection volume that can have a conical or pyramidal shape, and a portion of first outer layer 118 can be disposed within the projection volume defined by the sidewall projection.

Although FIG. 10 shows sidewall surface 140 comprising a single, substantially straight sidewall surface segment (e.g., a single-angle sidewall), other embodiments are included in this disclosure. For example, in some embodiments, the liquid lens comprises a multi-angle sidewall as described herein (e.g., in reference to FIG. 7). In some of such embodiments, the sidewall surface comprises a plurality of sidewall surface segments positioned at different sidewall angles, and the sidewall projection can comprise an imaginary extension of the sidewall surface segment having the smallest sidewall angle through the first outer layer. Additionally, or alternatively, in some embodiments, the liquid lens comprises a curved or arcuate sidewall segment. In some of such embodiments, the sidewall surface comprises a convex curved sidewall surface, and the sidewall projection can comprise an imaginary extension of a tangent line to the sidewall surface at a midpoint of the sidewall surface through the first outer layer. In some of such embodiments, the sidewall surface comprises a concave curved sidewall surface, and the sidewall projection can comprise an imaginary extension of a line through the endpoints of the sidewall surface through the first outer layer.

In some embodiments, central portion 118B of first outer layer 118 and/or first window 114 are defined by an intersection of sidewall projection 170 with the interior surface of the first outer layer. For example, central portion 118B of first outer layer 118 and/or first window 114 are a cylindrical portion of the first outer layer with a diameter defined by the circular intersection of sidewall projection 170 with the interior surface of the first outer layer. Central portion 118B of first outer layer 118 and/or first window 114 can have a circular cross-sectional shape as described in reference to FIG. 10 or a triangular, rectangular, or other polygonal or non-polygonal cross-sectional shape. In some embodiments, a thickness of central portion 118B of first outer layer 118 and/or first window 114 is uniform across the first window. For example, the thickness of first window 114 is substantially constant within a perimeter of the first window.

In some embodiments, peripheral portion 118A of first outer layer 118 can be defined by a portion of the first outer layer in contact with and/or bonded to intermediate layer 120. Additionally, or alternatively, peripheral portion 118A of first outer layer 118 can be defined by an outer edge of recess 119 (e.g., the farther outboard of the outer edge or perimeter of interior recess 119A or the outer edge or perimeter of exterior recess 119B). Additionally, or alternatively, recess portion 118C of first outer layer 118 can be defined by a portion of the first outer layer disposed between central portion 118B and peripheral portion 118A. In some embodiments, recess portion 118C of first outer layer 118 is disposed directly adjacent each of peripheral portion 118A and central portion 118B to define the contiguous first outer layer.

In some embodiments, interior recess 119A and/or exterior recess 119B are positioned outside of sidewall projection 170 of sidewall surface 140 of cavity 104 through first outer layer 118 as shown in FIG. 10. For example, interior recess 119A can comprise an annular recess circumscribing the window. Such an annular recess can comprise an inner edge or perimeter and an outer edge or perimeter. The inner edge can be positioned closer to structural axis 112 than the outer edge. In some embodiments, the inner edge of interior recess 119A is laterally spaced from sidewall projection 170 by an interior clearance distance. Additionally, or alternatively, exterior recess 119B can comprise an annular recess circumscribing the window and comprising an inner edge and an outer edge. In some embodiments, the inner edge of exterior recess 119B is laterally spaced from sidewall projection 170 by an exterior clearance distance. Positioning interior recess 119A and/or exterior recess 119B outside of sidewall projection 170 and/or spacing the interior recess and/or the exterior recess from the sidewall projection (e.g., by the respective interior clearance distance and/or exterior clearance distance) can help to prevent light that passes through the recess or edges thereof from passing through liquid lens 100, which could negatively impact image quality. In some embodiments, the interior clearance distance is equal or substantially equal to the exterior clearance distance, whereby interior recess 119A and exterior recess 119B are substantially equally spaced from sidewall projection 170. In other embodiments, the interior clearance distance is less than or greater than the exterior clearance distance.

In some embodiments, interior recess 119A comprises a greater lateral width than exterior recess 119B. For example, the angle of sidewall projection 170 may provide more lateral space for recess 119 at the interior surface of first outer layer 118 than at the exterior surface of the first outer layer. The additional lateral space at the interior surface can enable a relatively wider interior recess 119A compared to exterior recess 119B. In some embodiments, the inner edge of interior recess 119A is positioned laterally closer to structural axis 112 than the inner edge of exterior recess 119B. Additionally, or alternatively, the outer edge of interior recess 119A is substantially axially aligned with the outer edge of exterior recess 119B.

In some embodiments, the inner edge of interior recess 119A and/or the perimeter of central region 118B and/or first window 114 is laterally spaced from sidewall 140 by a lateral gap distance. If the lateral gap distance is too small, central region 118B and/or first window 114 may contact sidewall 140 (e.g., upon bending or flexing of first outer layer 118 as described herein). Additionally, or alternatively, if the lateral gap distance is too small, droplets of second liquid 106 may be formed at the gap (e.g., when the second liquid moves into the gap, such as during a shock event caused by a drop). If the lateral gap distance is too large, liquid lens 100 may be undesirably large relative to the optical aperture. In some embodiments, the lateral gap distance is about 0.01 mm, 0.02 mm, 0.03 mm, 0.04 mm, 0.05 mm, 0.06 mm, 0.07 mm, 0.08 mm, 0.09 mm, 0.1 mm, or any ranges defined by the listed values.

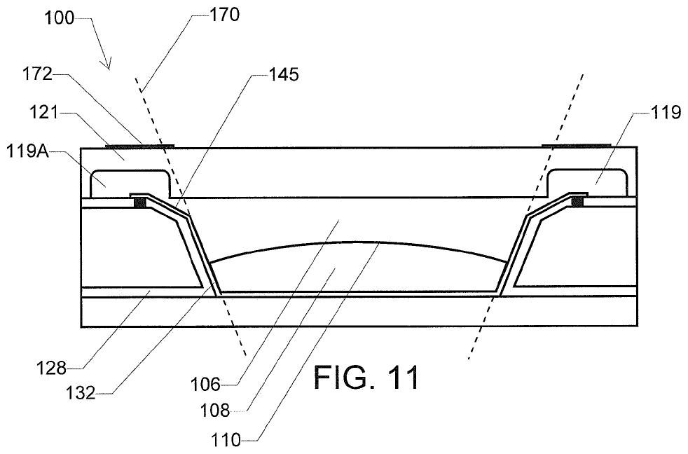

FIG. 11 is a schematic cross-sectional view of some embodiments of liquid lens 100. Liquid lens 100 shown in FIG. 11 is similar to the liquid lenses described in reference to FIGS. 1-10, and the common features described herein in connection with FIGS. 1-10 may not be repeated in connection with FIG. 11. In some embodiments, recess 119 comprises interior recess 119A, but is substantially free of an exterior recess. For example, the exterior surface of first outer layer 118 is substantially planar as shown in FIG. 11, with no recess formed or disposed therein. In some embodiments, flexure 121 comprises a thinned region of first outer layer 118 corresponding to recess 119 (e.g., interior recess 119A). For example, flexure 121 comprises a thinned region of first outer layer 118 axially aligned with recess 119 (e.g., interior recess 119A). In some embodiments, interior recess 119A is positioned outside of sidewall projection 170 of sidewall surface 140 of cavity 104 through first outer layer 118 as described herein. For example, interior recess 119A can comprise an annular recess circumscribing the window, and the inner edge of the interior recess can be laterally spaced from sidewall projection 170 by an interior clearance distance.

In some embodiments, liquid lens 100 comprises an aperture mask 172. For example, aperture mask 172 comprises an absorbing mask material disposed on the exterior surface of first outer layer 118. Aperture mask 172 can be substantially opaque to image light. For example, aperture mask 172 can be formed from an absorbing material that absorbs light in the wavelength range of the image light. For example, aperture mask 172 can be formed form a polymeric (e.g., black matrix), metallic (e.g., metal oxide), dielectric, or other suitable material. Aperture mask 172 can comprise a single layer or plurality of layers formed from the same or different materials. In some embodiments, aperture mask 172 has an optical density of 1, 1.1, 1.2, 1.3, 1.4, 1.5, 1.6, 1.7, 1.8, 1.9, 2, >2, or any ranges defined by the listed values. Aperture mask 172 can be formed using a suitable printing, coating, or deposition process (e.g., a physical vapor deposition, a chemical vapor deposition, and/or a lithographic process).

Aperture mask 172 can form an optical aperture at the entrance of liquid lens 100. Such an aperture can prevent stray light from outside of the intended field of view from entering liquid lens 100 and/or prevent light from passing through recess 119 or a portion thereof (e.g., the inner edge), thereby improving the image quality of the liquid lens. In some embodiments, aperture mask 172 comprises an annular shape as shown in FIG. 11. For example, the annular shape of aperture mask 172 comprises a width (e.g., a lateral ring width) of 0.01 mm, 0.02 mm, 0.03 mm, 0.04 mm, 0.05 mm, 0.06 mm, 0.07 mm, 0.08 mm, 0.09 mm, 0.1 mm, 0.11 mm, 0.12 mm, 0.13 mm, 0.14 mm, 0.15 mm, 0.16 mm, 0.17 mm, 0.18 mm, 0.19 mm, 0.2 mm, 0.3 mm, 0.4 mm, 0.5 mm, or any ranges defined by the listed values. In some embodiments, an outer edge of aperture mask 172 is disposed outside of sidewall projection 170. An inner edge of aperture mask 172 can be disposed within sidewall projection 170 as shown in FIG. 11 or outside of the sidewall projection. For example, aperture mask 172 can overlap first window 114 and/or circumscribe the first window. Additionally, or alternatively, aperture mask 172 can partially or entirely overlap flexure 121. For example, the inner edge of aperture mask 172 can be spaced from sidewall projection 170 by an aperture offset distance. For example, the aperture offset distance (e.g., inside or outside sidewall projection 170) can be 0.01 mm, 0.02 mm, 0.03 mm, 0.04 mm, 0.05 mm, 0.06 mm, 0.07 mm, 0.08 mm, 0.09 mm, 0.1 mm, 0.2 mm, 0.3 mm, 0.4 mm, 0.5 mm, or any ranges defined by the listed values. Although aperture mask 172 can be used in combination with configurations of first outer layer 118 comprising exterior recess 119B, the configuration of the first outer layer shown in FIG. 11 without the exterior recess may enable the aperture mask to be more robust and/or simpler to apply. For example, aperture mask 172 may be simpler to apply to a planar surface. Additionally, or alternatively, aperture mask 172 without sharp edges or corners (e.g., the corner at the inner edge of exterior recess 119B) may be less prone to cracking and/or delaminating from first outer layer 118.

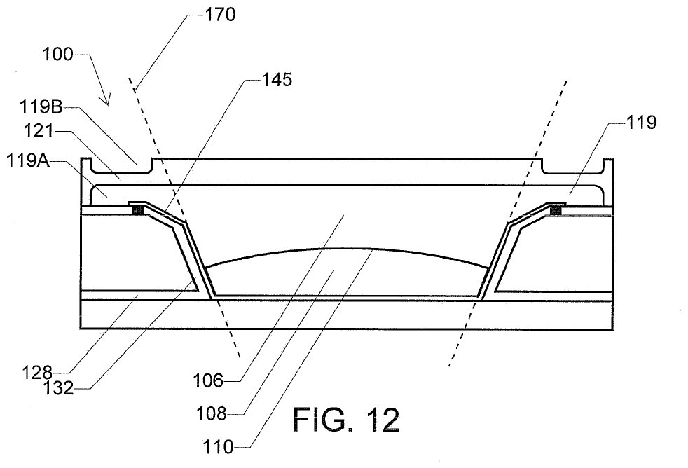

FIG. 12 is a schematic cross-sectional view of some embodiments of liquid lens 100. Liquid lens 100 shown in FIG. 12 is similar to the liquid lenses described in reference to FIGS. 1-11, and the common features described herein in connection with FIGS. 1-11 may not be repeated in connection with FIG. 12. In some embodiments, first outer layer 118 comprises interior recess 119A and exterior recess 119B. In some embodiments, interior recess 119A comprises a disc-shaped notch. For example, interior recess 119A extends across first window 114 (e.g., as opposed to an annular notch circumscribing a central region corresponding to the first window). In some embodiments, interior recess 119A comprises an outer edge or perimeter, but is free of any inner edge or perimeter. For example, the outer edge of interior recess 119A is disposed outside of sidewall projection 170, and the interior recess extends across the sidewall projection. In some embodiments, exterior recess 119B comprises an annular recess as described herein.

In some embodiments, flexure 121 is substantially centered with respect to a thickness of first outer layer 118. For example, a depth of interior recess 119A is substantially equal to a depth of exterior recess 119B, whereby flexure 121 is axially centered on first outer layer 118. A depth of interior recess 119A can be the axial distance between the interior surface of first outer layer 118 (e.g., the interior surface of peripheral portion 118A in contact with or bonded to intermediate layer 120) and a floor of the interior recess (e.g., the interior surface of flexure 121 disposed within the interior recess). Additionally, or alternatively, a depth of exterior recess 119B can be the axial distance between the exterior surface of first outer layer 118 (e.g., the exterior surface of peripheral portion 118A) and a floor of the exterior recess (e.g., the exterior surface of flexure 121 disposed within the exterior recess). The depths of interior recess 119A and/or exterior recess 119B can be determined by the amount of first outer layer 118 that is removed (e.g., etched or machined) to form the respective recesses (e.g., beginning with a planar substrate of uniform thickness). For example, interior recess 119A can be formed by removing material from recess portion 118C and central portion 118B of a substantially planar sheet of material. Additionally, or alternatively, exterior recess 119B can be formed by removing material from recess portion 118C, without removing material from central portion 118B. In some embodiments, the outer surface of central portion 118B can be substantially coplanar with the outer surface of peripheral portion 118A. The depths of interior recess 119A and/or exterior recess 119B can be measured with first outer layer 118 in the planar configuration as described herein.

In some embodiments, flexure 121 is decentered with respect to the thickness of first outer layer 118. For example, the depth of interior recess 119A is substantially different than the depth of exterior recess 119B, whereby flexure 121 is axially offset on first outer layer 118. In some embodiments, the depth of interior recess 119A is less than the depth of exterior recess 119B. For example, flexure 121 is axially offset toward the interior surface of first outer layer 118. In some embodiments, the exterior surface of central portion 118B of first outer layer 118 and/or first window 114 is substantially coplanar with the exterior surface of the first outer layer (e.g., the exterior surface of peripheral portion 118A). The shallower interior recess 119A relative to the deeper exterior recess 119B can enable central portion 118B of first outer layer 118 and/or first window 114 to be thicker compared to embodiments in which flexure 121 is axially centered. For example, because interior recess 119A extends across central portion 118B of first outer layer 118 and/or first window 114, reducing the depth of the interior recess can reduce the amount of the central portion and/or the first window that are removed upon forming the interior recess. The increased thickness of central portion 118B of first outer layer 118 and/or first window 114 can improve the temperature stability of liquid lens 100 (e.g., by reducing flexing of the first window) as described herein.

In some embodiments, the depth of interior recess 119A is greater than the depth of exterior recess 119B. For example, flexure 121 is axially offset toward the exterior surface of first outer layer 118.

The combination of the disc-shaped interior recess 119A and the annular exterior recess 119B shown in FIG. 12 can enable liquid lens 100 to be relatively stable over a wide operating temperature range while also reducing stray light within the liquid lens, thereby improving image quality. For example, first window 114 can have a uniform thickness, which can be relatively thicker than flexure 121. Such a configuration can enable first outer layer 118 to flex or bend (e.g., at flexure 121) with expansion and/or contraction of first liquid 106 and/or second liquid 108 (e.g., as a result of temperature changes), while limiting the bending of first window 114 (e.g., as a result of its relatively greater thickness), which could cause unintended changes in the focal length of liquid lens 100. In some embodiments, a ratio of the thickness of central region 118B and/or first window 114 to the thickness of flexure 121 is 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or any ranges defined by the listed values. Increasing the ratio of the thickness of central region 118B and/or first window 114 to the thickness of flexure 121 can reduce the bowing of the first window and/or increase the flexibility of the flexure in response to changes in temperature as described herein. Additionally, or alternatively, interior recess 119A without an inner edge can reduce the potential for stray light passing through the edge to enter liquid lens 100, which could degrade the image quality.

If the depth of interior recess 119A is too small, central region 118B and/or first window 114 may contact sidewall 140 (e.g., upon bending or flexing of first outer layer 118 as described herein). Additionally, or alternatively, if the depth of interior recess 119A is too small, droplets of second liquid 106 may be formed at the gap between intermediate layer 120 and first outer layer 118 (e.g., when the second liquid moves into the gap, such as during a shock event caused by a drop). In some embodiments, the depth of interior recess 119A is about 0.01 mm, 0.02 mm, 0.03 mm, 0.04 mm, 0.05 mm, 0.06 mm, 0.07 mm, 0.08 mm, 0.09 mm, 0.1 mm, or any ranges defined by the listed values.

Although liquid lens 100 described in reference to FIG. 12 comprises sidewall surface 140 and chamfer surface 145, other embodiments are included in this disclosure. For example, in some embodiments, the chamfer surface is omitted, and the sidewall surface extends to the peripheral surface of the intermediate layer (e.g., to the first or upper surface of the intermediate layer circumscribing the bore in the intermediate layer). The configuration of the interior recess can help to enable omission of the chamfer surface, for example, because the recess extending across the first window helps to maintain the gap between the intermediate layer and the first window without the presence of the chamfer surface.

Any of the various configurations of first outer layer 118 shown in FIGS. 10-12 can be implemented with any combination of the chamfer, the aperture mask, the multi-angle sidewall, and/or the step described herein.

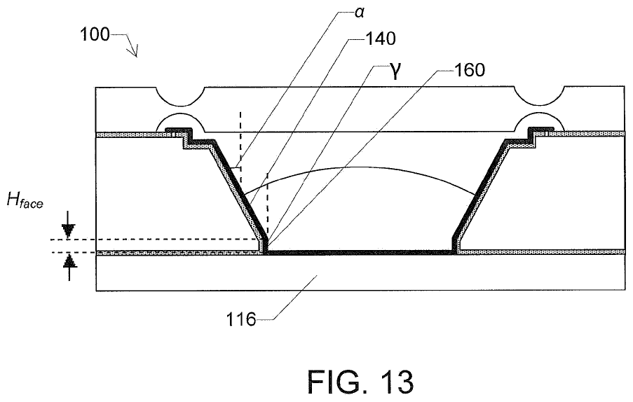

FIG. 13 is a schematic cross-sectional view of some embodiments of liquid lens 100. Liquid lens 100 shown in FIG. 13 is similar to the liquid lenses described in reference to FIGS. 1-12, and the common features described herein in connection with FIGS. 1-12 may not be repeated in connection with FIG. 13. In some embodiments, sidewall 140 of cavity 104 is disposed or extends at angle α to structural axis 112. Additionally, or alternatively, sidewall 140 or a portion thereof can be straight as described herein. In some embodiments, cavity 104 comprises a face 160 disposed between (e.g., axially between) sidewall 140 and second window 116. For example, face 160 is disposed or extends at an angle γ to structural axis 112. In some embodiments, angle γ is smaller than angle α. For example, face 160 is parallel or substantially parallel to structural axis 112 such that angle γ is about 0° as shown in FIG. 13. In other embodiments, angle γ is larger than angle α. In some embodiments, face 160 is straight (e.g., as described herein in reference to sidewall 140 or a portion thereof).

In some embodiments, sidewall 140 comprises an angled or conical portion of cavity 104 and/or face 160 comprises a peripheral bevel formed in a portion of the cavity (e.g., a lower portion of the cavity adjacent the cavity floor or between the sidewall and the cavity floor) as shown in FIG. 13. For example, face 160 comprises a substantially cylindrical bevel disposed at a lower peripheral portion of the bore in intermediate layer 120 between sidewall 140 and second outer layer 122 and/or second window 116. In some embodiments, face 160 comprises a height H_{face}, measured from the floor of cavity 104. For example, H_{face} is about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, or any ranges defined by the listed values.

In some embodiments, face 160 is implemented in combination with recess 119 and step 150 without the multi-angle sidewall 140 as shown in FIG. 13. In other embodiments, any combination of one or more of face 160, sidewall 140 (e.g., the multi-angle sidewall or the single-angle sidewall), recess 119 (e.g., having any of the various configurations described herein), chamfer 145, step 150, and/or aperture mask 172 can be implemented.

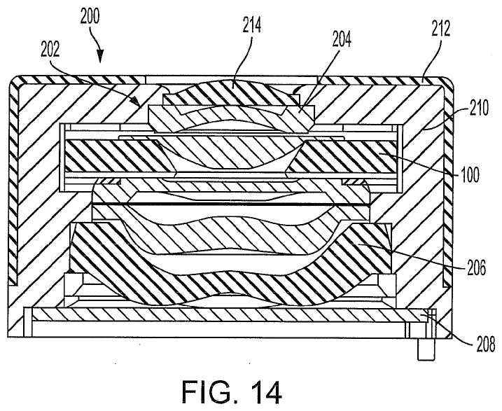

FIG. 14 is a schematic cross-sectional view of some embodiments of an imaging device 200. For example, imaging device 200 can be configured as a camera module operable to capture still images and/or record video. In some embodiments, imaging device 200 comprises a lens assembly 202. For example, lens assembly 202 comprises a first lens group 204, liquid lens 100, and a second lens group 206 aligned along an optical axis. In some embodiments, structural axis 112 of liquid lens 100 can be aligned with the optical axis of lens assembly 202. Each of first lens group 204 and second lens group 206 can comprise, independently, one or a plurality of lenses (e.g., fixed lenses).

Although lens assembly 202 is described herein as comprising liquid lens 100, other embodiments are included in this disclosure. In some embodiments, the lens assembly comprises a variable focus lens, which can be a liquid lens (e.g., liquid lens 100) or electrowetting-based liquid lens, a hydrostatic fluid lens (e.g., comprising a fluid or polymeric material disposed within a flexible membrane with a curvature that is variable, for example, by injecting or withdrawing fluid and/or by applying an external force to the fluid lens), a liquid crystal lens, or another type of lens having a focal length that can be changed (e.g., without translating, tilting, or otherwise moving the lens assembly relative to the image sensor).

Although lens assembly 202 is described herein as comprising liquid lens 100 disposed between first lens group 204 and second lens group 206, other embodiments are included in this disclosure. In some other embodiments, a lens assembly comprises a single lens or a single lens group disposed on either side (e.g., the object side or the image side) of liquid lens 100 along the optical axis.

In some embodiments, imaging device 200 comprises an image sensor 208. For example, lens assembly 202 is positioned to focus an image on image sensor 208. Image sensor 208 can comprise a semiconductor charge-coupled device (CCD), a complementary metal-oxide-semiconductor (CMOS), an N-type metal-oxide-semiconductor (NMOS), another image sensing device, or a combination thereof. Image sensor 208 can detect image light focused on the image sensor by lens assembly 202 to capture the image represented by the image light. In some embodiments, image sensor 208 can repeatedly capture images represented by the image light to record a video.

In some embodiments, imaging device 200 comprises a housing 210. For example, lens assembly 202 and/or image sensor 208 are mounted in housing 210 as shown in FIG. 14. Such a configuration can help to maintain proper alignment between lens assembly 202 and image sensor 208. In some embodiments, imaging device 200 comprises a cover 212. For example, cover 212 is positioned on housing 210. Cover 212 can help to protect and/or shield lens assembly 202, image sensor 208, and/or housing 210. In some embodiments, imaging device 200 comprises a lens cover 214 disposed adjacent lens assembly 202 (e.g., at the object side end of the lens assembly). Lens cover 214 can help to protect lens assembly 202 (e.g., first lens group 204) from scratches or other damage.

In some embodiments, a field of view (FOV) of the variable focus lens (e.g., liquid lens 100) remains substantially constant during focus adjustment. Such constant FOV can be enabled by the lack of physical movement (e.g., translation in a direction parallel to the optical axis) of liquid lens 100 and/or optical system 202 relative to image sensor 208. Additionally, or alternatively, such constant FOV can enable varying the focus of liquid lens 100 without compensating for variations at the edges of the resulting image incident on image sensor 208 (e.g., variations caused by a changing FOV with changing focus), which can reduce processing power used by imaging device 200 (e.g., for compensating for such variations).

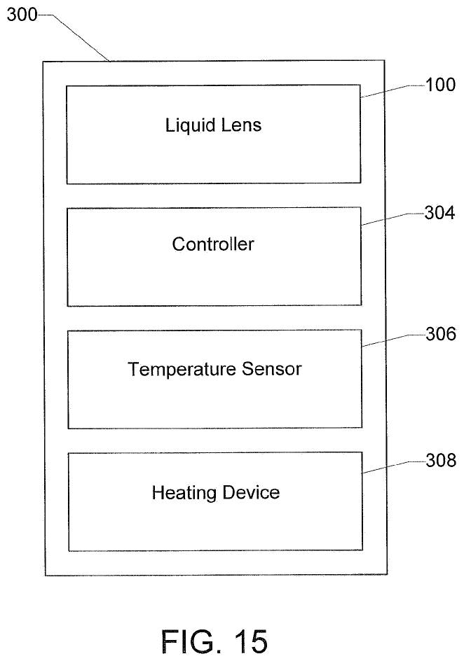

FIG. 15 is a block diagram illustrating some embodiments of an imaging system 300. In some embodiments, imaging system 300 comprises a variable focus lens, such as for example, liquid lens 100. In some embodiments, imaging system 300 comprises a controller 304. Controller 304 can be configured to supply a common voltage to common electrode 124 of liquid lens 100 and a driving voltage to driving electrode 126 of the liquid lens. A shape of interface 110 of liquid lens 100 and/or a position of the interface of the liquid lens can be controlled by the voltage differential between the common voltage and the driving voltage. In some embodiments, the common voltage and/or the driving voltage comprises an oscillating voltage signal (e.g., a square wave, a sine wave, a triangle wave, a sawtooth wave, or another oscillating voltage signal). In some of such embodiments, the voltage differential between the common voltage and the driving voltage comprises a root mean square (RMS) voltage differential. Additionally, or alternatively, the voltage differential between the common voltage and the driving voltage is manipulated using pulse width modulation (e.g., by manipulating a duty cycle of the differential voltage signal), pulse amplitude modulation (e.g., by manipulating the amplitude of the differential voltage signal), another suitable control method, or a combination thereof.

In various embodiments, controller 304 can comprise one or more of a general processor, a digital signal processor, an application specific integrated circuit, a field programmable gate array, an analog circuit, a digital circuit, a server processor, combinations thereof, or other now known or later developed processor. Controller 304 can implement one or more of various processing strategies, such as multi-processing, multi-tasking, parallel processing, remote processing, centralized processing, or the like. Controller 304 can be responsive to or operable to execute instructions stored as part of software, hardware, integrated circuits, firmware, microcode, or the like.

In some embodiments, imaging system 300 comprises a temperature sensor 306, which can be integrated into liquid lens 100, imaging device 200, or another component of the imaging system. Temperature sensor 306 can be configured to detect a temperature within imaging device 200 (e.g., within liquid lens 100) and generate a temperature signal indicative of the detected temperature. In some embodiments, the voltage differential between the common voltage and the driving voltage is based at least in part on a temperature signal generated by the temperature sensor, which can enable compensation for changing electrical properties and/or physical properties of the liquid lens with changes in temperature.

In some embodiments, imaging system 300 comprises a heating device 308, which can be integrated into liquid lens 100, imaging device 200, or another component of the imaging system. Heating device 308 can be configured to introduce heat into imaging device 200 (e.g., into liquid lens 100) to increase the temperature of the imaging device, or a portion thereof. Such heating can help to enable the improved speed and/or image quality of the liquid lens.

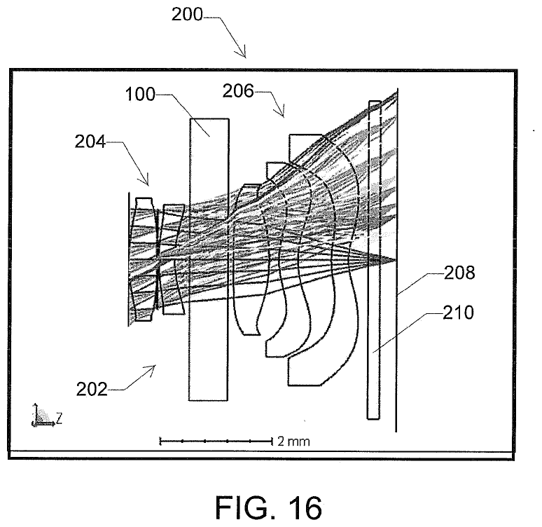

FIG. 16 is a schematic ray diagram of some embodiments of imaging device 200. In some embodiments, imaging device 200 comprises lens assembly 202 comprising first lens group 204, liquid lens 100, and second lens group 206 aligned along the optical axis. In the embodiments shown in FIG. 16, first lens group 204 comprises two fixed lenses, and second lens group 206 comprises three fixed lenses. In other embodiments, the first and second lens group can comprise more or fewer lenses. In some embodiments, imaging device 200 comprises image sensor 208 and an infrared (IR) cut filter 210, and lens assembly 202 is positioned to focus an image through the IR cut filter onto the image sensor.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A liquid lens comprising:
a first substrate comprising an interior recess;
a second substrate comprising a bore and bonded to the first substrate, whereby the interior recess of the first substrate and the bore of the second substrate cooperatively define at least a portion of a cavity of the liquid lens;
a first liquid disposed in the cavity;
a second liquid disposed in the cavity; and
a variable interface disposed between the first liquid and the second liquid, thereby forming a variable lens;
wherein the interior recess of the first substrate is positioned outside of a sidewall projection of a sidewall surface of the cavity through the first substrate.

2. The liquid lens of claim 1, wherein:
the cavity comprises a chamfer surface disposed between the sidewall surface and the first substrate; and
a chamfer angle between the chamfer surface and a structural axis of the liquid lens is greater than a sidewall angle between the sidewall surface and the structural axis of the liquid lens.

3. The liquid lens of claim 2, wherein:
the second substrate comprises a peripheral surface circumscribing the bore;
the first substrate is bonded to the peripheral surface of the second substrate; and
the chamfer surface of the cavity extends between the sidewall surface of the cavity and the peripheral surface of the second substrate.

4. The liquid lens of claim 3, wherein the cavity comprises a step disposed between the chamfer surface of the cavity and the peripheral surface of the second substrate.

5. The liquid lens of claim 1, wherein the sidewall projection comprises a conical shape or a pyramidal shape.

6. The liquid lens of claim 1, wherein:
the sidewall surface comprises one or more continuous sidewall segments; and
a position of a perimeter of the variable interface on the sidewall surface is adjustable to adjust at least one of a focus or a tilt of the liquid lens.

7. The liquid lens of claim 1, wherein:
the first substrate comprises a window and a periphery circumscribing the window; and
the interior recess is disposed in the periphery of the first substrate.

8. The liquid lens of claim 7, wherein a perimeter of the window is defined by the sidewall projection on an interior surface of the first substrate.

9. The liquid lens of claim 7, wherein a thickness of the window is substantially uniform across the window.

10. The liquid lens of claim 7, wherein the interior recess comprises an annular recess circumscribing the window.

11. The liquid lens of claim 7, wherein:
the first substrate comprises an exterior recess; and
the exterior recess of the first substrate is positioned outside of the sidewall projection of the sidewall surface of the cavity through the first substrate.

12. The liquid lens of claim 11, wherein the first substrate comprises a flexure disposed between the interior recess and the exterior recess.

13. The liquid lens of claim 11, wherein the interior recess comprises a greater lateral width than the exterior recess.

14. The liquid lens of claim 11, wherein an inner edge of the interior recess is positioned laterally closer to a structural axis of the liquid lens than an inner edge of the exterior recess.

15. The liquid lens of claim 11, wherein an outer edge of the interior recess is substantially axially aligned with an outer edge of the exterior recess.

16. The liquid lens of claim 11, wherein:
an inner edge of the interior recess is laterally spaced from the sidewall projection by an interior clearance distance;
an inner edge of the exterior recess is laterally spaced from the sidewall projection by an exterior clearance distance; and
the interior clearance distance is substantially the same as the exterior clearance distance.

17. The liquid lens of claim 7, wherein:
the first substrate comprises a flexure corresponding to the interior recess; and
the flexure has a reduced stiffness compared to the window, whereby the flexure is movable to enable the window to translate in an axial direction in response to a change in at least one of a temperature or a pressure within the cavity.

18. The liquid lens of claim 1, comprising an annular aperture mask disposed on an exterior surface of the first substrate.

19. A liquid lens comprising:
a first substrate comprising an interior recess and a substantially planar exterior surface, the interior recess comprising an annular shape;
a second substrate comprising a bore and bonded to the first substrate, whereby the interior recess of the first substrate and the bore of the second substrate cooperatively define at least a portion of a cavity of the liquid lens;
a first liquid disposed in the cavity;
a second liquid disposed in the cavity; and
a variable interface disposed between the first liquid and the second liquid, thereby forming a variable lens;
wherein the cavity comprises a sidewall surface and a chamfer surface disposed between the sidewall surface and the first substrate;
wherein a sidewall angle between the sidewall surface and a structural axis of the liquid lens is less than a chamfer angle between the chamfer surface and the structural axis of the liquid lens; and
wherein the interior recess of the first substrate is positioned outside of a sidewall projection of the sidewall surface through the first substrate.

20. A liquid lens comprising:
a first substrate comprising an interior recess and an exterior recess, the interior recess extending across a window of the first substrate, the exterior recess comprising an annular recess;
a second substrate comprising a bore and bonded to the first substrate, whereby the interior recess of the first substrate and the bore of the second substrate cooperatively define at least a portion of a cavity of the liquid lens, the cavity comprising a sidewall surface disposed at a sidewall angle between the sidewall surface and a structural axis of the liquid lens;
a first liquid disposed in the cavity;
a second liquid disposed in the cavity; and
a variable interface disposed between the first liquid and the second liquid, thereby forming a variable lens;
wherein light passing directly through the liquid lens at any angle within a sidewall projection of the sidewall surface passes through the first substrate without passing through an edge of the interior recess; and
wherein the exterior recess is positioned outside of the sidewall projection of the sidewall surface of the cavity through the first substrate.
